(19) United States
(12) Patent Application Publication
(10) Pub. No.: US 2007/0091213 A1
(43) Pub. Date: Apr. 26, 2007

(54) Luminance control method and luminance control apparatus for controlling a luminance, computer program and a computing system

(75) Inventor: Cornelis Antoine Maria Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/570,544

(22) PCT Filed: Aug. 26, 2004
(86) PCT No.: PCT/IB04/51578

§ 371 Date: Mar. 3, 2006

(30) Foreign Application Priority Data
Sep. 12, 2003 (EP) 03103375.6

(51) Int. Cl. H04N 9/68; H04N 5/57

(52) U.S. Cl. 348/687; 348/645

(57) ABSTRACT

In present television sets, user color saturated control is executed in a nonlinear signal domain due to the gamma conversion inherent of the camera. This results in the display of exaggerated colors when the saturated control is increased. The present invention provides a A luminance control method comprising the steps of providing an original image signal ((Y′, R′−Y′, B′−Y′)) having a luminance component (Y′) and a color component (R′−Y′, B′−Y′) to a first processing stream and a second processing stream, wherein the first processing stream comprises the steps of: applying a saturation control to the original image signal ((Y′, R′−Y′, B′−Y′)) resulting in a saturation controlled image signal ((Y′, sat*(R′−Y′), sat*(B′−Y))), and predicting a first predicted image signal ((Ys″, Rs″−Ys″, Bs″−Ys″)) by further processing thereof; the second processing stream comprises the steps of predicting a second predicted image signal ((Y1″, R1″−Y1″, B1″−Y1″)) by processing of the original image signal ((Y′, R′Y′, B′−Y′)); providing a correction factor (Y1″/Ys″) by comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″)); applying the correction factor (Y1″/Ys″) to correct one of the image signals of the first processing stream to give a display signal (Ro′, Go′, Bo′)). Thereby the current invention maintains the luminance output as a function of the saturation control. Le. the luminance of the display is predicted for the case where the saturation is amended. This predicted luminance is higher or lower due to the increased or decreased saturation and compared with the predicted luminance with unamended saturation. This comparison provides a correction factor that is applied to an image signal with amended saturation before the image signal is applied to the display. The result is that at an increasing saturation control a very natural change of the colors occurs where the conventional method of saturation control will cause an exaggerated and unnatural color reproduction.

### FIELD OF THE INVENTION

The present invention relates to a luminance control method and a luminance control apparatus for controlling a luminance in a display or imaging system. Further the present invention relates to a computer program and a computing system.

### TECHNICAL BACKGROUND

The user color saturation control in television sets or digital still and video cameras or many computer applications is executed in a non-linear signal domain due to the gamma conversion inherent of the camera which registers the video or still pictures. This non-linear camera signal is the reason why an increasing saturation control results in the display of exaggerated colors, especially the blue, red and magenta colors. For instance the amplitude increase of the RGB colors may be exaggerated at a factor of nine as compared to yellow colors.

In particular such disadvantages arrise if an LCD display is used as a display in an imaging system of the mentioned kind. In an LCD display only a certain maximum amount of light, i.e. luminance, is available due to the technical limits of the liquid crystals used in the display. Conventional methods of saturation control, especially an increase of saturation, will in any case cause an exaggerated and unnatural color reproduction.

### DESCRIPTION OF THE PRIOR ART

Systems, like the one disclosed in EP 1 237 379 A2 provide algorithms for remapping a color gamut between certain color systems, like between a CMY or RGB system and Commission Internationale l'Eclairage (CIE)-LAB system. A similar application is known from JP 2000-050299. In U.S. Pat. No. 5,867,169 a method for manipulating color values in a computer graphic system is described.

All methods of known kind make specific model assumptions based on empirical values for color reproduction, which only in general seem to be appropriate to display natural colors. These assumptions may work well when no extra measures are applied to adapt an image to specific demands with regard to the saturation. However, such kind of general assumption also has some significant drawbacks as outlined with regard to the technical background. In particular, the prior art concepts described below do not account for changes in the luminance when a saturation control is applied.

For instance in EP 0 533 100 A2 a gradation correction apparatus for processing R, G and B input signals include: a luminance signal conversion device before gamma conversion for obtaining the original luminance signal from the input signals, a luminance gamma conversion device, a correction coefficient calculation means, a first RGB operation means, a color difference signal operation means, a second RGB operation means and an RGB determination means. Such apparatus is directed to adapt the dynamic range of a TV to the specific and limited dynamic range of a printer. Instead of the brightness or luminance therefore the gamma conversion is adapted to be able to keep the hue and the saturation of the color gamut constant. However, the teaching of EP 0 533 100 A2 consequently makes certain assumptions, for instance a linear source signal is assumed. Therefore, the teaching of EP 0 533 100 A2 does not provide any flexible help, which would be adapted to a variety of situations. Due to the general assumptions of the gradation correction apparatus of EP 0 533 100 A2, said apparatus will not be able to maintain the luminance as a function of saturation control for each variable and specific case of an applied saturation control.

U.S. Pat. No. 5,786,871 addresses problems arising when a video camera or an other kind of a pick up device provides a color signal. Such color signal is converted usually by a matrix into three new component signals having a luminance component (Y) and two color difference components (Y′, R−Y′, B−Y′), the coefficients for the matrix being a function of the particular television standard. The component signals may then be gamma corrected, for instance in accordance with the well known Weber-Fechner relation, which represents the dynamic response of the human eye as being approximately logarithmic. The gamma-corrected luminance (Y) and color difference signals (R′−Y′, B′−Y′) may then be encoded into a composite video signal, such as a NTSC or PAL signal, for transmission. At the receiving end a decoder converts the composite video signal into the gamma-corrected component signals, which internally are converted by an inverse gamma circuit into the component signals. The component signals are then input to an inverse matrix to reproduce the original RGB signals for display. Such an ideal system has all of the brightness information processed by the luminance channel, which is commonly called a “constant luminance” system.

As a color TV working with a cathode ray tube (CRT) inherently has a non linear transmission characteristic proving a gamma-kind transfer, the gamma correction compresses the dynamic range of the RGB signals to improve the subjective system signal to noise ratio for low brightness elements at the expense of a lessened signal to noise ratio for high brightness elements. The teaching of U.S. Pat. No. 5,786,871 helps to provide an encoder that anticipates the true brightness information that is lost in the chrominance channels and applies an appropriate correction to the luminance channel before transmission. Thereby a constant luminance corrector is defined for extracting lost brightness information from the chrominance channels and adding it back into the luminance channel prior to encoding. The gamma corrected component signals are input to a luminance predictor circuit. From these signals the luminance predictor circuit produces a luminance correction signal corresponding to the lost brightness information from the chrominance channels. However, such luminance predictor circuit merely predicts an ideal luminance with regard to a constant luminance scheme effected by the limited band width of an encoder and decoder. Also here no measures are given, which would be appropriate to adapt a luminance as a function of applied saturation control for each specific and varying case. Instead the above teaching again relies on general assumptions, which are unflexible in their application.

None of such systems is able to maintain the luminance output of a display, be it a cathode ray tube (CRD), liquid crystal display (LCD) or plasma display panel (PDP), as a function of the saturation control. The result is, that conventional methods of saturation control cause an exaggerated and unnatural color reproduction. However, desirable is a result where a very natural change of the colors should occur, even upon amended saturation control.

### OBJECT OF THE INVENTION

This is where the invention comes in, the object of which is to specify a luminance control method and apparatus for controlling a luminance such that upon amending the saturation control the luminance is maintained as a function of the saturation control.

### SUMMARY OF THE INVENTION

As regards the method, the object is achieved by a luminance control method comprising the steps of:
providing an original image signal ((Y′, R′−Y′, B′−Y′)) having a luminance component (Y′) and a color component (R′−Y′, B′−Y′) to a first processing stream and a second processing stream,

wherein

the first processing stream comprises the steps of:

applying a saturation control to the original image signal ((Y′, R′−Y′, B′−Y′)) resulting in a saturation controlled image signal ((Y′, sat*(R′−Y′), sat*(B′−Y′))), and

predicting a first predicted image signal ((Ys″, Rs″−Ys″, Bs″−Ys″)) by further processing thereof;

the second processing stream comprises the steps of:

predicting a second predicted image signal ((Y1″, R1″−Y1″, B1″−Y1″)) by processing of the original image signal ((Y′, R′−Y′, B′−Y′));
providing a correction factor (Y1″/Ys″) by comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″));
applying the correction factor (Y1″/Ys″) to correct one of the image signals of the first processing stream to give a display signal ((Ro′, Go′, Bo′)).

The main idea of the invention is to predict the luminance of the display for the case where the saturation is amended by means of the first processing stream and respectively a luminance of the display is predicted for the case where the saturation remains unamended by means of the second processing stream. For the case the saturation is increased, this predicted luminance is higher due to the increased saturation and compared with the predicted luminance without increased saturation. The comparison provides the correction factor which is applied to correct one of the image signals of the first processing stream to give a display signal.

Such concept has major advantages. For instance the invention also works in the linear domain, for example for a PDP display or a linearized display matrix that incorporates the saturation as well. In that case, it still limits a too high increase of individual colors. As a result the picture quality is improved even at high or low saturation levels. For instance exaggerated and unnatural looking colors are prevented at an increasing saturation control. It has become possible to apply an increasing saturation control for LCD's without an unacceptable crossing of the light output reach of the LCD causing a loss of picture details by an unnatural compression due to the LCD transfer curve. A color dependent loss of light when decreasing the color saturation control, even in case of a black and white picture, is achieved. The idea of maintenance of the luminance output of the display as a function of the saturation control offers the advantage of providing natural looking images for each specific and variable case of a saturation controlled image signal.

Developed configurations of the invention are further outlined in the dependent method claims. Thereby the mentioned advantages of the proposed concept are even more improved.

In a particular preferred configuration the first processing stream comprises the steps of:

applying the saturation control to a color component (R′−Y′, B′−Y′) of the original image signal ((Y′, R′−Y′, B′−Y′)) resulting in the saturation controlled image signal (Y′, sat*(R′−Y′), sat*(B′−Y′)) and

predicting the first predicted image signal ((Ys″, Rs″−Ys″, Bs″−Ys″)) by:
converting the saturation controlled image signal ((Y′, sat*(R′−Y′), sat*(B′−Y′))) into a first saturation controlled RGB-image signal ((Rs′, Gs′, Bs′)) having a saturation controlled red (Rs′), green (Gs′) and blue (Bs′) color component,
gamma-converting the first saturation controlled RGB-image signal ((Rs′, Gs′, Bs′)) into a second saturation controlled RGB-image signal ((Rs″, Gs″, Bs″)), and
converting the second saturation controlled RGB-image signal ((Rs″, Gs″, Bs″)) into the first predicted image signal (Ys″, Rs″−Ys″, Bs″−Ys″).

As a further preferred configuration the second processing stream comprises the steps of:

predicting the second predicted image signal ((Y1″, R1″−Y1″, B1″−Y1″)) by:
converting the original image signal ((Y′, R′−Y′, B′−Y′)) into a first RGB-image signal ((R′, G′, B′)) having a red (R′), green (G′) and blue (B′) color component,
gamma-converting the first RGB-image signal (R′, G′, B′) into a second RGB-image signal ((R″, G″, B″)), and
converting the second RGB-image signal ((R″, G″, B″)) into the second predicted image signal ((Y1″, R1″−Y1″, B1″−Y1″)).

The above mentioned developed configurations in particular provide a non-linear transfer in form of the gamma conversion, a color space converter starting and ending with RGB-signals, which transmits the luminance signal (Y) and the color different signals (R−Y, B−Y) and a saturation control, most preferably also implying a black level control. Both adjustments, the black level and the saturation control, are applied in the non-linear color space due to the gamma of a camera or a display. The black level control is a DC offset added to the luminance signal Y and the saturation control is a gain control of the color difference signals (R−Y, B−Y).

A detailed description of these configurations will be given in chapters 1 and 2 of the detailed description.

It is, of course, not possible to describe every conceivable configuration of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

A particular preferred configuration is described in detail with regard to FIG. 14 in chapter 3 of the detailed description. This configuration allows to apply the correction factor by:
multiplying the second saturation controlled RGB-image signal ((Rs″, Gs″, Bs″)) with the correction factor (Y1″/Ys″), and
inversely gamma-converting the multiplied second saturation controlled RGB-image signal ((Ro″, Go″, Bo″)) to give the display signal ((Ro′, Go′, Bo′)).

A further preferred configuration is described in chapter 3 of the detailed description with regard to FIG. 29. In said configuration the correction factor is applied by:
inversely gamma-converting the correction factor (Y1″/Ys″), and
multiplying the first saturation controlled RGB-image signal ((Rs′, Gs′, Bs′)) with the inversely gamma-converted correction factor (Y1″/Ys″) to give the display signal ((Ro′, Go′, Bo′)).

Still a further preferred configuration is described in chapter 3 of the detailed description with regard to FIG. 30, in said configuration the correction factor is applied by:
inversely gamma-converting the correction factor (Y1″/Ys″), and
multiplying the saturation controlled image signal ((Y′, sat*(R′−Y′), sat*(B′−Y′))) with the inversely gamma-converted correction factor (Y1″/Ys″) to give the display signal ((Ro′, Go′, Bo′)) (FIG. 30).

As regards the apparatus the object is achieved by a luminance control apparatus (11, FIG. 14a) for controlling the luminance comprising:
an input means (12) for providing an original image signal ((Y′, R′−Y′, B′−Y′)) having a luminance component (Y′) and a color component (R′−Y′, B′−Y′) to a first processing stream (14) and a second processing stream (16),

wherein

the first processing stream (14) comprises:

a control means (14a) for applying a saturation control to the original image signal ((Y′, R′−Y′, B′−Y′)) resulting in a saturation controlled image signal ((Y′, sat*(R′−Y′), sat*(B′−Y′))), and

a first prediction means (14b) for predicting a first predicted image signal ((Ys″, Rs″−Ys″, Bs″−Ys″)) by further processing thereof;

the second processing stream (16) comprises:

a second prediction means (16a) for predicting a second predicted image signal ((Y1″, R1″−Y1″, B1″−Y1″)) by processing of the original image signal ((Y′, R′−Y′, B′−Y′));
a comparator means (18) for providing a correction factor (Y1″/Ys″) and comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″));
an operator means (19) for applying the correction factor (Y1″/Ys″) to correct one of the image signals of the first processing stream (14) to give a display signal ((Ro′, Go′, Bo′)).

Such apparatus is in particular adapted to execute the method as outlined above and to achieve the advantages thereof.

In a particular preferred configuration the luminance control apparatus (11) comprises in the first processing stream (14):

a control means (14a) for applying a saturation control to the original image signal ((Y′, R′−Y′, B′−Y′)) resulting in a saturation controlled image signal ((Y′, sat*(R′−Y′), sat*(B′−Y′))), and

a first prediction means (14b) for predicting a first predicted image signal ((Ys″, Rs″−Ys″, Bs″−Ys″)) by (FIG. 14b):
converting (20) the saturation controlled image signal ((Y′, sat*(R′−Y′), sat*(B′−Y′))) into a first saturation controlled RGB-image signal ((Rs′, Gs′, Bs′)) having a saturation controlled red (Rs′), green (Gs′) and blue (Bs′) color component,
gamma-converting (22) the first saturation controlled RGB-image signal ((Rs′, Gs′, Bs′)) into a second saturation controlled RGB-image signal ((Rs″, Gs″, Bs″)), and
converting (24) the second saturation controlled RGB-image signal ((Rs″, Gs″, Bs″)) into the first predicted image signal ((Ys″, Rs″−Ys″, Bs″−Ys″)).

In a further preferred configuration such luminance control apparatus (11) comprises the second processing stream (16):

a second prediction means (16a) for predicting a second predicted image signal ((Y1″, R1″−Y1″, B1″−Y1″)) by (FIG. 14c):
converting (26) the original image signal ((Y′, R′−Y′, B′−Y′)) into a first RGB-image signal ((R′, G″, B′)) having a red (R′), green (G″) and blue (B″) color component,
gamma-converting (28) the first RGB-image signal ((R′, G″, B′)) into a second RGB-image signal ((R″, G″, B″)), and
converting (30) the second RGB-image signal ((R″, G″, B″)) into the second predicted image signal ((Y1″, R1″−Y1″, B1″−Y1″)).

In a particular preferred embodiment the apparatus is formed as a device comprising an interconnected circuit of particular kind or other kind of preferable circuitry adapted to execute the method as outlined above.

Such device may be incorporated in a means for receiving the original signal and displaying the image by the display signal. For instance such device may be incorporated in a television system or directly in a CRT, LCD or PDP-display.

Consequently such apparatus also has to be understood to be formed by an imaging system. An advantageous embodiment of such an imaging system (1) is described in detail with regard to FIG. 1 in the detailed description. In particular the imaging system (1) may comprise:

register means (2) for registering an image (3) and providing the original image signal (4), like a camera or other kind of pick up device for scanning an image,

transfer means (5) for coding (6), transfering (7) and decoding (8) the original image signal (4), like a NTSC or PAL transmission, and

display means (9) for receiving the original image signal (4) and displaying the image (3) by the display signal (10), like a CRT, LCD or PDP display.

In another configuration said luminance control apparatus comprises a means for receiving an image in form of the original image signal and displaying the image by the display signal. In a particular advantageous application said control apparatus is formed as an LCD display, in particular as a computer LCD display. In a further particular advantageous application said control apparatus is formed as a printer, in particular as a printer for a computer.

The invention also leads to a computer program product storable on a medium readable by a computing, imaging and/or printer system, comprising a software code section which induces the computing, imaging and/or printer system to execute the method as outlined above when the product is executed on the computing, imaging and/or printer system.

Further the invention leads to a computing, imaging and/or printer system for executing the computer program product. A semiconductor device for executing or storing the computer program product and a storage medium for storing the computer program product is also part of the invention.

Whereas the invention has particular utility for displays and will be described as associated with a television system, it should be understood that the apparatus and its method of operation are also operable in association with other forms of imaging systems. For example the concept of the invention is also applicable for camera systems, computer systems, any kind of displays, in particular LCD displays, and color printers.

For a more complete understanding of the invention, the invention will now be described in detail with reference to the accompanying drawing. The detailed description will illustrate and describe, what is considered as the preferred embodiment of the invention. It should of course be understood that various modifications and changes in form or detail could merely be made without departing from the spirit of the invention. It is therefore intended that the invention may not be limited to the exact form and details shown and described herein, nor to anything less than the whole of the invention disclosed herein and as claimed hereinafter. Further the features described in the description, the drawing and the claims disclosing the invention, may be essential for further developed configurations of the invention considered alone or in combination.

### BRIEF DESCRIPTION OF THE FIGURES

The drawing shows in:

FIG. 1 a basic diagram of the calorimetric functions of a television system;

FIG. 2 a CRT output in the 2D Uniform Chromaticity-Scale Surface (UCS)1976 color plane (bottom) and chrominance″ color plane (top) after a saturation control of 1.2;

FIG. 3 a relative RGBmax″ light output in the 3D UCS1976 color space (left) and chrominance″ color space (right) after a saturation control of 1.2;

FIG. 4 a side projection of the relative RGBmax″ in the 3D UCS1976 color space (left) and chrominance″ color space (right) after a saturation control of 1.2 for a CRT display;

FIG. 5 a saturation control of 1.2 in the linear UCS1976 color space (left) and chrominance 3D color space (right) with the luminance signal on the vertical axis;

FIG. 6 a side projection of a saturation control of 1.2 in the linear 3D UCS1976 color space (left) and chrominance color space (right) with the luminance signal Y in the vertical direction;

FIG. 7 a side projection of a saturation control of 1.2 after a camera gamma of 1/2.3 in the 3D UCS1976 color space (left) and chroma color space (right) with the luma signal Y′ in the vertical direction;

FIG. 8 a side projection of a saturation control of 1.2 after a camera gamma of 1/2.3 and a CRT gamma of 2.3 in the 3D UCS1976 color space (left) and chrominance″ color space (right) with the Y″ output in the vertical direction;

FIG. 9 a 3D UCS1976 color space (left) and chrominance″ color space (middle) with the Y″ output expressed in the European Broadcasting Union (EBU) luminance contributions. On the right side the chrominance″ side projection is shown;

FIG. 10 a normalized LCD transfer curve;

FIG. 11 differences in the 2D UCS1976 plane (bottom) and chrominance″ plane (top) of a CRT output (left) and an LCD output (right) after a saturation control of 1.2;

FIG. 12 a side projection of the relative RGBmax″ in the 3D UCS1976 color space (left) and chrominance″ color space (right) after a saturation control of 1.2 for an LCD display. Linear input signals are used as reference input points;

FIG. 13 differences in side projection of the UCS1976 and chrominance″ space of a CRT output (left) and an LCD output (right) after a saturation control of 1.2;

FIG. 14 a block diagram of the luminance control apparatus according to the invention;

FIG. 14a the main parts of a preferred embodiment of the luminance control apparatus according to the invention;

FIG. 14b the first prediction means of the preferred embodiment of the luminance control apparatus according to the invention;

FIG. 14c the second prediction means of the preferred embodiment of the luminance control apparatus according to the invention;

FIG. 15 maintenance of the luminance″ output Y″ of the display in the UCS1976 space (left) and chrominance″ space (right), with RGBmax″ on the vertical axis, after a saturation control of 1.2;

FIG. 16 a side projection of the Y″ maintenance of the display output in the UCS1976 space (left) and chrominance″ space (right), with RGBmax″ on the vertical axis, after a saturation control of 1.2;

FIG. 17 a side projection of the luminance″ maintenance of the display output in the UCS1976 space (left) and chrominance″ space (right), with Y″ on the vertical axis, after a saturation control of 1.2;

FIG. 18 differences in 2D color reproduction without and with maintenance of the luminance″ output Y″ after a saturation control of 1.2;

FIG. 19 a side and top projection of the display output in the UCS1976 space (left) and chrominance″ space (right), with Y″ on the vertical axis, after a saturation control of 0.6;

FIG. 20 a side and top projection of the luminance″ maintenance of the display output in the UCS1976 space (left) and chrominance″ space (right), with Y″ on the vertical axis, after a saturation control of 0.6;

FIG. 21 a side and top projection of the display output in the UCS1976 space (left) and chrominance″ space right, with Y″ on the vertical axis, after a saturation control of 0.3;

FIG. 22 a side and top projection of the luminance″ maintenance of the display output in the UCS1976 space (left) and chrominance″ space (right), with Y″ on the vertical axis, after a saturation control of 0.3;

FIG. 23 a side and top projection of the display output in the UCS1976 space (left) and chrominance″ space (right), with Y″ on the vertical axis, after a saturation control of 0.0;

FIG. 24 a side and top projection of the luminance″ maintenance of the display output in

the UCS1976 space (left) and chrominance″ space (right), with Y″ on the vertical axis, after a saturation control of 0.0;

FIG. 25 maintenance of the luminance″ output Y″ of the display in the UCS1976 space (left) and chrominance″ space (right), with RGBmax″ on the vertical axis, after a saturation control of 0.6;

FIG. 26 maintenance of the luminance″ output Y″ of the display in the UCS1976 space (left) and chrominance″ space (right), with RGBmax″ on the vertical axis, after a saturation control of 0.3 (top) and 0.0 (bottom);

FIG. 27 a side projection of the Y″ maintenance of the LCD output in the UCS1976 color space (left) and chrominance″ color space (right) with maintenance of the luminance″ output as a function of a saturation control of 1.2 for an LCD display;

FIG. 28 a side projection of the Y″ maintenance of the CRT (top) and LCD (bottom) output in the UCS1976 space (left) and chrominance″ space (right), with RGBmax″ on the vertical axis, after a saturation control of 1.2;

FIG. 29 a first variation of maintenance of the luminance″ output Y″ of the display after the saturation control as shown in FIG. 14;

FIG. 30 a second variation of maintenance of the luminance″ output Y″ of the display after the saturation control as shown in FIG. 14;

FIG. 31 a saturation control for a PDP (Plasma Display Panel) display;

FIG. 32 a PDP luminance″ output without negative primary contributions in the UCS1976 space (left) and chrominance″ space (right), with Y″ on the vertical axis;

FIG. 33 maintenance of the luminance″ output Y″ of a PDP after the saturation control;

FIG. 34 a PDP luminance″ output with Y″ maintenance in the UCS1976 space (left) and chrominance″ space (right), with Y″ on the vertical axis;

FIG. 35 maintenance of the luminance″ output Y″ of the display after the saturation control and the option of extra luminance″ with the Extra-Y-maintenance parameter;

FIG. 36 as horizontal lines a luminance″ output with Y″ maintenance for sat=1.4 and YmaintGain=1.0—in slanted lines the very same but with YmaintGain=1.1;

FIG. 37 a second variation of maintenance of the luminance″ output Y″ of the display after the saturation control as shown in FIG. 14;

FIG. 38 an increase of 20% of the saturation control in the linear UCS1976 and chrominance color plane;

FIG. 39 a saturation control of 1.2 in the linear UCS1976 space (left) and three dimensional (3D) color space (right), with RGBmax on the vertical axis;

FIG. 40 a side projection of the linear UCS1976 space (left) and chrominance color space (right), showing the RGBmax amplitude increase at a saturation control of 1.2;

FIG. 41 a location of a negative primary color contribution during the signal processing;

FIG. 42 a concept for preventing negative color contributions in the linear chrominance plane (top) and UCS1976 plane (bottom);

FIG. 43 a concept for preventing the contribution of negative colors in the linear 3D UCS1976 space (left) and chrominance color space (right);

### DETAILED DESCRIPTION OF THE FIGURES

1. A Television System

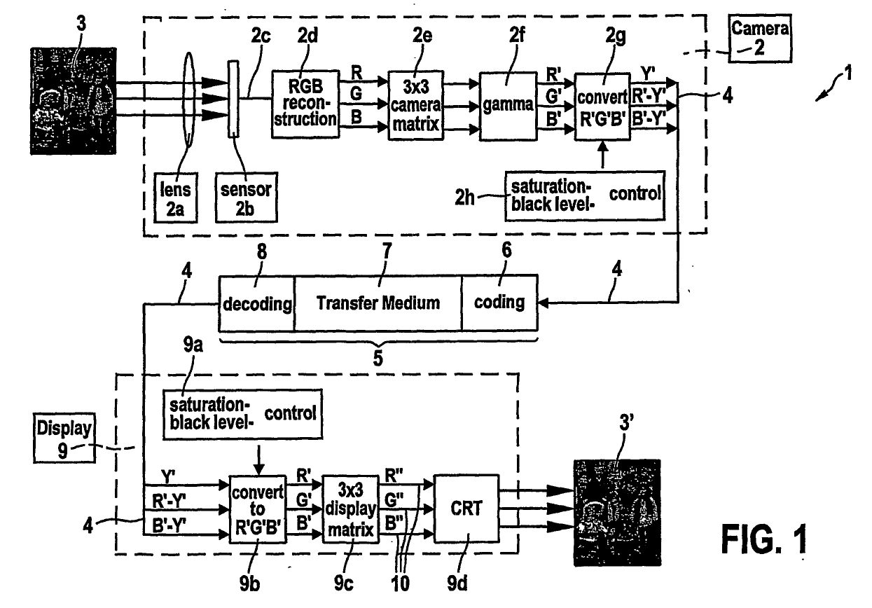

FIG. 1 shows a basic diagram of an imaging system 1 being formed as a television system consisting of three main parts. On the top a camera 2 is shown, which is a preferred embodiment of a register means for registering an image 3 and providing the original image signal 4. In the middle a transfer means 5 for coding, transferring and decoding the original image 3 is shown. The transfer means 5 provides a coding device 6 for coding the original image signal 4, a transfer medium 7 for transferring the original image signal 4 and a decoding device 8 for decoding the original image signal 4. At the bottom a television display with the conventional CRT is shown as a preferred embodiment of a display means 9 for receiving the original image 4 and displaying the image 3 by the display signal 10 in form of the displayed image 3′. The camera 2 and the television 9 and all calorimetric aspects are shown in FIG. 1.

1.1 The Camera

On the upper-left corner of FIG. 1 a scene is registered in form of an image 3 by the camera 2 via a lens 2a and a single light sensitive area image sensor 2b, with an RGB (Red-Green-Blue) color array on it. A lot of color arrays for camera's using a single image sensor exist. The most popular are the Bayer array with a primary color RG/GB structure and the complementary mosaic array with a YeCy/GMg structure (Yellow-Cyan, Green-Magenta) with a row alternating GMg to MgG. The latter color abbreviations will also be used throughout the figures. In order to convert the multiplexed RGB signal 2c from the image sensor 2b to three continuous RGB signals in parallel, an RGB reconstruction filter 2d is needed. If by means of an optical RGB color splitter three image sensors are applied, then of course no RGB reconstruction is needed. Next the RGB signals are offered to a 3×3 camera matrix 2e for fitting the color gamut of the camera to a desired television standard like the EBU-standard (European Broadcasting Union) or HDTV-standard (High Definition Television).

After the matrix the camera gamma 2f is applied, which is intended for compensating the non-linear transfer of the CRT at the end of the display unit in FIG. 1.

Finally in the camera the R′G′B′ signals are converted (2g) to the Luma (luminance) signal Y′ and the color difference signals R′−Y′ and B′−Y′.

After the conversion 2g a black level control 2h is applied wherein the black level can be adjusted by adding a DC-level to the Luma signal Y′. The saturation can be adjusted by multiplying the color difference signals with it.

1.2 The Transfer Medium

Using the transfer means 5, before the transfer medium 7 in FIG. 1 a coder 6 has been applied, and thereafter a decoder 8. The type of coder 6 and decoder 8 will depend on the type of the transfer medium 7. Important is that whatever the transfer medium 7 will be, its function is that the Luma signal Y′ and the color difference signals R′−Y′ and B′−Y′ of the camera 2, are reproduced at the input of the display unit 9 as perfect as possible. From a colorimetric point of view the coding method determines the applied reduction factors of the color difference signals R′−Y′ and B′−Y′.

1.3 The Display

Also the display means 9 begins with a black level control 9a. The camera unit 2 ends with a black level control 2h. The black level control 9a of the display means 9 acts on the Luma signal and a saturation control 9a on the color difference signals. Next the Luma signal and the color difference signals are converted (9b) back to R′G′B′ signals again.

If the color gamut of the display does not correspond with the gamut of the camera (i.e. EBU or HDTV), then a 3×3 display matrix 9c can be applied in order to minimize the color reproduction errors.

Finally there is the CRT 9d wherein the scene registered by the camera 2 in form of the image 3 via its gamma transfer characteristic is displayed in form of the displayed image 3′. Still there is a discussion on about the exact definition of the gamma of the present CRT's. It will be understood that a proper choice of the gamma is left up to a particular application. Here, in this context, a CRT gamma of 2.3 is used. Besides a CRT there are other displays like an LCD and a PDP (Plasma Display Panel).

Concerning FIG. 1 it can be seen that from a colorimetric point of view there are:
two non-linear transfers, the gamma 2f of the camera 2 and the gamma of the CRT 9d of the display 9,
two color space converters 2g and 9b, starting and ending with R′G′B′ signals and the transfer means 5 in between. The transmitted signals are the Luma signal Y′ and the color difference signals R′−Y′ and B′−Y′.
two black level and two saturation controls, 2h and 9a. In principle these can be seen as only one control for each when ignoring the transfer means 5. Both adjustments of the controls 2h and 9a, the black level and the saturation, are applied in the non-linear color space due to the gamma 2f of the camera 2. The black level control is a DC offset added to the Luma signal Y′ and the saturation control is a gain control of the color difference signals R′−Y′ and B′−Y′.
   2. The 3D Analysis of the Color Saturation Control

The three dimensional (3D) analysis of the color saturation control will make clear that the characteristics of the display 9 become involved as there are the transfer of the display, the maximum reach of its drivers and the color gamut of the display. Also the maximum voltage reach of the electronic circuitry will play a role when adjusting the color saturation. For purposes of elucidation the camera gamma 2f has got the inverse exponent of the CRT gamma, i.e. 1/2.3.

2.1 The Relative CRT Light Output After the Camera Gamma and a Saturation Control of 1.2

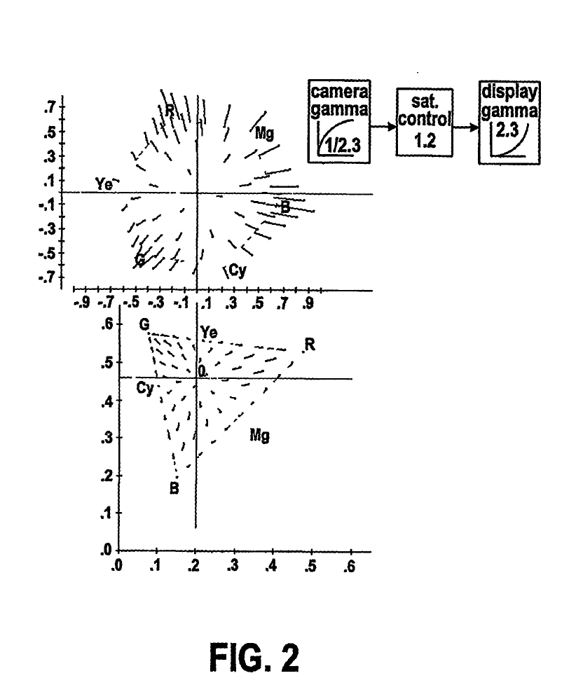

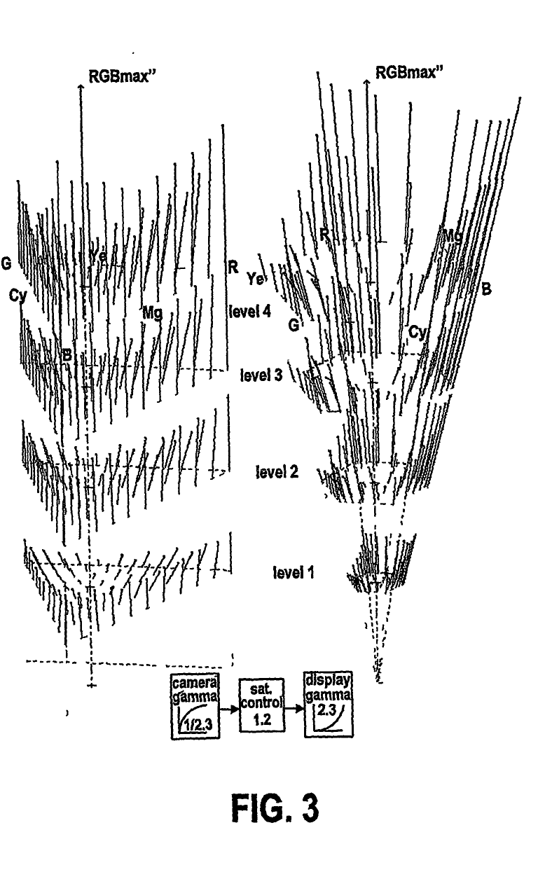

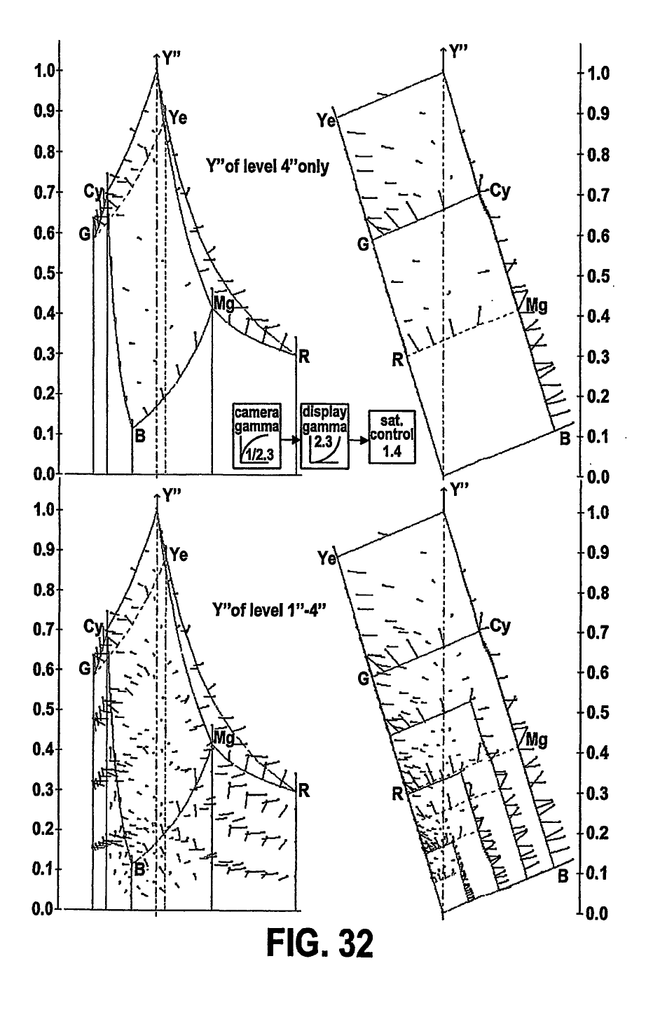

The relative RGBmax″ light output, i.e. the light output of the maximum of the R″G″B″ CRT outputs, is shown to be normalized to unity nits (cd/m²) for linear RGB input signals of 1.0 Volts and upon neglecting the individual luminance contributions. From the linear input signal and the camera output to the non-linear display in this case will give an idea of what happens with the reference colors in the 2D planes and 3D spaces with RGBmax″ as the vertical dimension. Because a display is not able to show the result of a negative primary color contribution, a negative RGB signal will be limited to zero. As a consequence, illustrated in FIG. 2, the oversaturated colors at the borders will be limited to the borders of the color gamut. Compared with the lower Uniform Chromaticity-Scale Surface (UCS) 1976 plane the 3D cone structure of the upper chrominance″ plane will cause a misleading saturation increase outside the hexagon. It is to be noticed that a linear input signal is used as a reference for the arrows in the figures of this section. Because the overall transfer of the camera and display is unity the linear input reference points could also be regarded as the linear display output for a saturation control of 1.0. The 3D version of figure is shown in FIG. 32 with RGBmax″ in the vertical direction. The relative RGBmax″ light output increased a lot, especially for the blue, red and magenta colors. In FIG. 3 the color reproduction is shown for four levels 1, 2, 3 and 4 in the vertical direction.

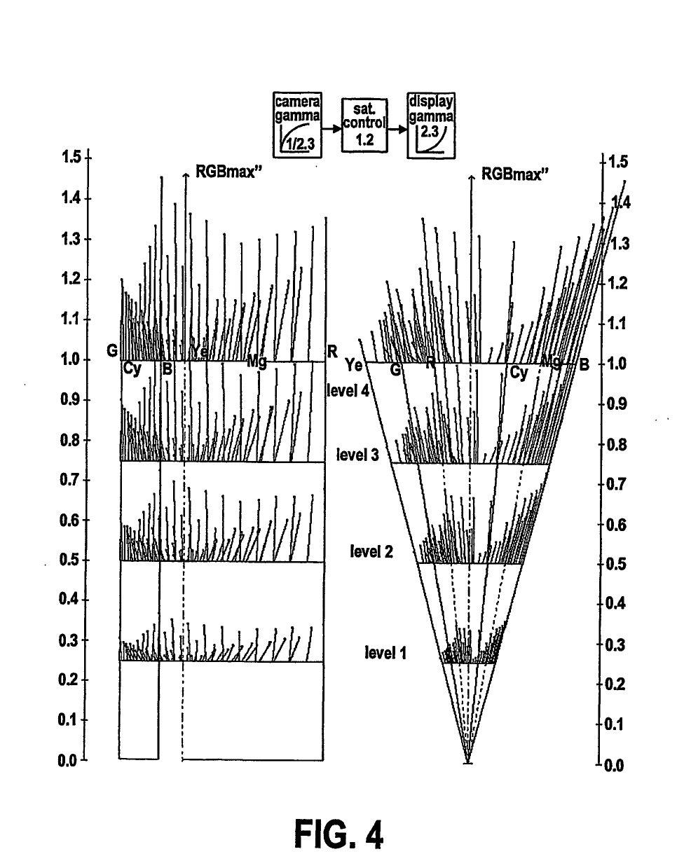

For a linear blue input color with B=1 and R=G=0 the RGBmax′ output, i.e. the B′-signal after the camera gamma, is: sat×(B′−Y′)+Y′=1.2×(1−0.114)=1.1772 Volt. After the CRT the relative RGBmax″ light output will become: 1.1772^{2.3}=1.4553 times larger. The side projection in FIG. 4 gives a better view on this increase of the maximum of the R″G″B″ CRT light outputs.

The relative RGBmax″ value is a measure for the change of the absolute light output in cd/m² of the color corresponding with RGBmax″. An increase of RGBmax″ with 1.4553 times for the previously mentioned blue color, also means that the light output of the blue primary will increase as much.

The FIGS. 3 and 4 clearly show that at the border input colors the amplitude increase of the blue color is the largest one followed by respectively the red and magenta colors. The yellow color has the smallest amplitude increase followed by respectively the cyan and green colors. This means that the consequences of a saturation increase will affect the yellow, cyan and green colors in a scene much less than the blue, red and magenta colors. In the next section it will become clear that the increase of the absolute light output of the primary color corresponding with RGBmax″, will be proportional to the increase RGBmax″.

2.2 Color Saturation Analysis in the 3D Chroma Space with Luma on the Vertical Axis

In the following the color spaces are shown with the luminance″ signal on the vertical axis. The Luma signal of the camera (Y′) powered to the exponent of the display results in the luminance″ signal (Y″). It can be regarded as a two times powered signal: first by the gamma of the camera and finally by the gamma of the display.

For elucidation purposes here the Federal Communications Commission (FCC) luminance contributions have been applied instead of the EBU ones. For the FCC luminance contributions the relation holds:
Y_{R}:Y_{G}:Y_{B}=0.299:0.587:0.114.

The luminance″ output represents the absolute CRT light output, i.e. the primary luminance contributions of the display expressed in cd/m² (nits).

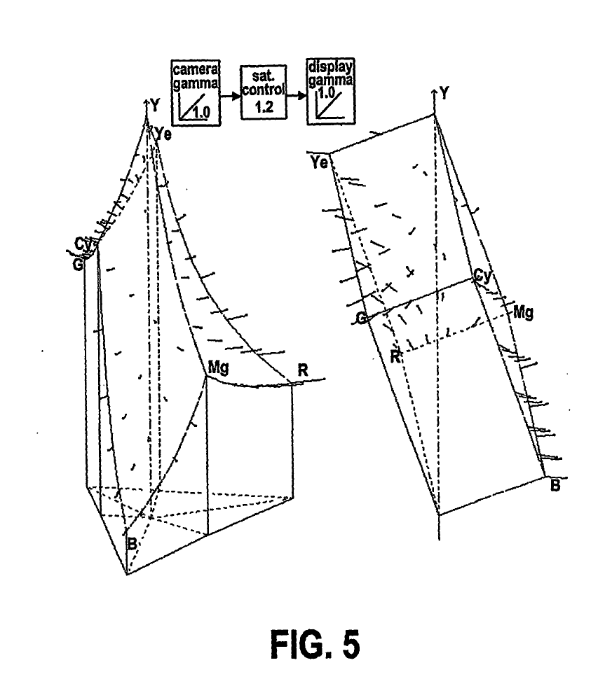

At first the linear 3D color space reproductions with the luminance signal on the vertical axis and a saturation control of 1.2 is explained. In spite of showing the reference points of level 4 only, FIG. 5 does not really give an idea what has happened with those reference points. It shows perfectly well why in the figures the RGBmax signal has been preferably chosen on the vertical axis. In order to give sense to the 3D color spaces with the luminance″ signal Y″ on the vertical axis, in this section only the much more interesting side projections are shown.

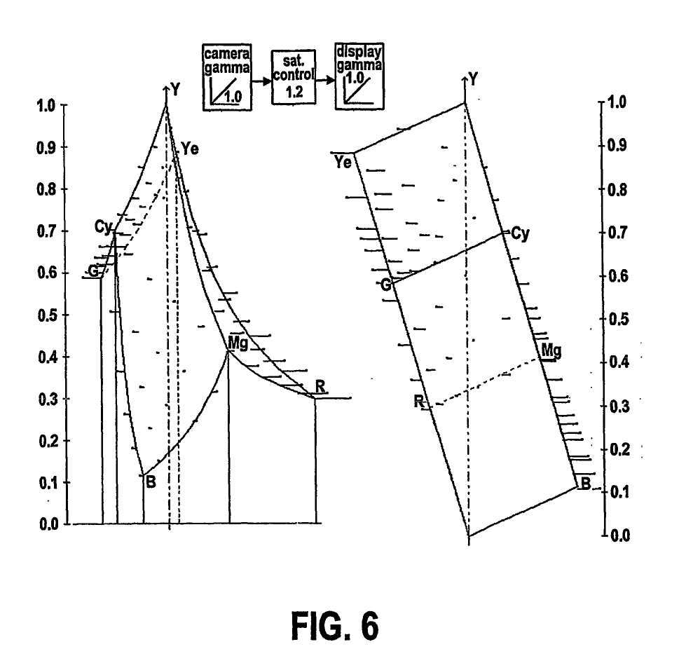

A striking feature of FIG. 6 is that all arrows, representing a saturation control of 1.2 for the reference points, are horizontal. This means that the luminance output of arbitrary colors in those linear 3D spaces are independent of the amount of color saturation. It can easily be proven that the luminance signal Y is maintained after an increase (or decrease) of the saturation. For the luminance signal the relation holds:
Y=Y_{R}×R+Y_{G}×G+Y_{B}×B

The color difference signals inclusive the saturation parameter are:
R−Y=sat×(R−Y)
G−Y=sat×(G−Y)
B−Y=sat×(B−Y)

This results in the following RGB-signals:
R=sat×R−sat×Y+Y
G=sat×G−sat×Y+Y
B=sat×B−sat×Y+Y

Substituting those RGB-signals in the previous luminance signal equation gives:

$$Y = {Y}_{R} \times sat \times R - {Y}_{R} \times sat \times Y + {Y}_{R} \times Y + {Y}_{G} \times sat \times G - {Y}_{G} \times sat \times Y + {Y}_{G} \times Y + {Y}_{B} \times sat \times B - {Y}_{B} \times sat \times Y + {Y}_{B} \times Y = sat \times ( {Y}_{R} \times R + {Y}_{G} \times G + {Y}_{B} \times B ) - sat \times Y ( {Y}_{R} + {Y}_{G} + {Y}_{B} ) + Y \times ( {Y}_{R} + {Y}_{G} + {Y}_{B} )$$

Because Y_{R}×R+Y_{G}×G+Y_{B}×B=Y and Y_{R}+Y_{G}+Y_{B}=1 it follows that: Y=sat×Y−sat×Y+Y=Y, i.e. Y is independent of the saturation parameter.

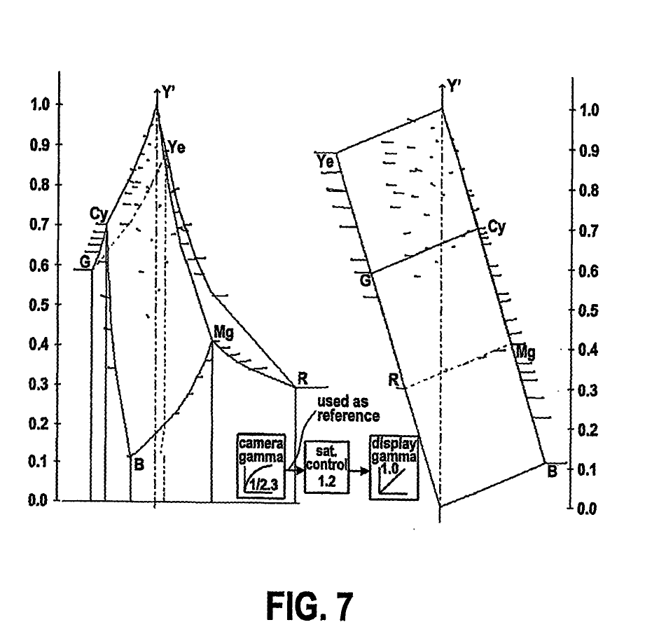

FIG. 7 shows the side projection in the 3D UCS1976 and Chroma space with the Luma signal Y′ in the vertical direction after a camera gamma of 1/2.3. For the Luma signal Y′ the relation holds:
Y′=0.114×R′+0.587×G′+0.114×B′

The points after the camera gamma have been taken as input reference points instead of the linear ones before the camera gamma. Also here the arrows are horizontal, meaning that the Luma signal Y′ is independent of the amount of color saturation.

By replacing the R, G, B and Y-signals by the R′, G′, B′ and by Y′-signals respectively in an analog way as here before it can be proven that the Luma signal Y′ is maintained as a function of the saturation. One conclusion is that in the linear 3D color space as well as the one after the camera gamma, the Y(′) increase caused by the increased RGBmax(′)is fully cancelled primarily by the Y(′) decrease of the other two primaries. Of course the very same counts in case of a decrease of the color saturation.

This also means that a saturation increase in the linear 3D color space as well as in the one after the camera gamma with RGBmax(′) as a vertical dimension, the increase of RGBmax(′) only represents the increase of the RGBmax(′) color signal, while the Y(′) signal amplitude is maintained. Again the very same counts in case of a decrease of the saturation. This maintenance of the luminance output after modifying the color saturation does however not count after the CRT, i.e. after the CRT gamma transfer. Before the gamma of the CRT the relation holds:
R′=sat×R′−sat×Y′+Y′
G′=sat×G′−sat×Y′+Y′
B′=sat×B′−sat×Y′+Y′

For being able to continue the calculations it is supposed that the CRT gamma is equal to 2, i.e.:
R″=(sat×R′+(1−sat)×Y′)²=(sat×R′)²+2×sat×R′×(1−sat)×Y′+((1−sat)×Y′)²
G″=(sat×G′+(1−sat)×Y′)²=(sat×G′)²+2×sat×G′×(1−sat)×Y′+((1−sat)×Y′)²
B″=(sat×B′+(1−sat)×Y′)²=(sat×B′)²+2×sat×B′×(1−sat)×Y′+((1−sat)×Y′)²

For Y″ the relation holds:
Y″=Y_{R}×R″+Y_{G}×G″+Y_{B}×B″
Substituting R″, G″ and B″ in Y″ gives:

$${Y}^{″} = {Y}_{R} \times ( {( sat \times {R}^{′} )}^{2} + 2 \times sat \times {R}^{′} \times ( 1 - sat ) \times {Y}^{′} + {( ( 1 - sat ) \times {Y}^{′} )}^{2} ) + {Y}_{G} \times ( {( sat \times {G}^{′} )}^{2} + 2 \times sat \times {G}^{′} \times ( 1 - sat ) \times {Y}^{′} + {( ( 1 - sat ) \times {Y}^{′} )}^{2} ) + {Y}_{B} \times ( {( sat \times {B}^{′} )}^{2} + 2 \times sat \times {B}^{′} \times ( 1 - sat ) \times {Y}^{′} + {( ( 1 - sat ) \times {Y}^{′} )}^{2} )$$

This result can be simplified further. However, it cannot be made independent of the saturation parameter “sat”.

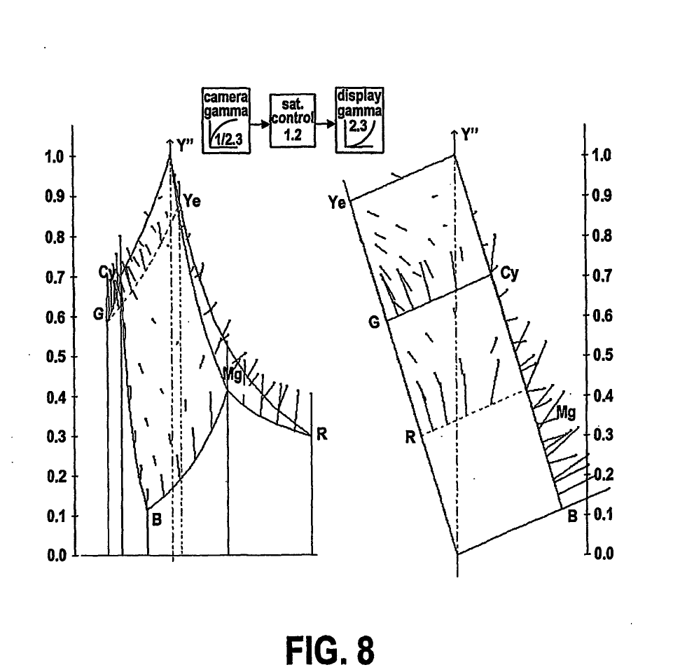

In FIG. 8 the Y″ CRT output increase after a saturation increase is shown. For example for the blue color with B=1 and R=G=0 after the camera gamma the relation holds that B′=sat×(B′−Y′)+Y′. After the CRT this becomes B″=Y_{B}×(sat×(B″−Y″)+Y″)^{2.3} cd/m².

The parameter Y_{B} is the relative luminance output of the blue phosphor expressed in terms of cd/m², being the relative EBU luminance contributions for modern displays. Most modern displays have green and blue phosphors that are very close near the EBU chromaticity coordinates. The red phosphor however is shifted towards the green chromaticity coordinates and deviates relatively much from the preferred EBU-ones. Given a saturation control of 1.2 this means that B″=Y_{B}×1.4453. This relative large luminance increase of blue has been already predicted in the previous section 2.1. Moreover it corresponds with the RGBmax″ increase. It is to be noticed that the linear input signals are used as reference points.

The conclusion of this section is that after the CRT the Y″ luminance output will change as function of the amount of saturation. This means that a saturation adjustment results in a color vector consisting of two vectors after the CRT: a Y″ luminance vector in the vertical direction and a let's say true saturation vector in the horizontal plane.

It is to be noticed that the 2D planes in FIG. 2 represent the top projection of the 3D color spaces with Y″ as vertical dimension but also for the 3D spaces in FIG. 3 with the relative RGBmax″ output as vertical dimension.

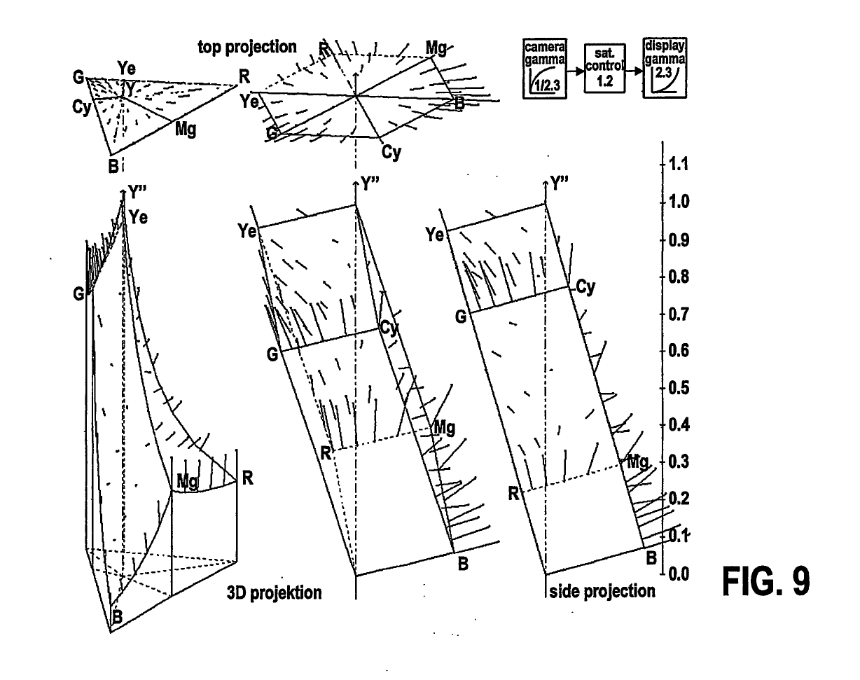

Because modem displays should have luminance contributions according to the EBU the side projection as the one in FIG. 9 is a more realistic one. Here the EBU coordinates are only shown once because it limits the comparison of the different steps in this section going from linear to beyond the camera gamma and finally to the CRT output. On the left side and in the middle the 3D UCS1976 and chrominance″ spaces are shown inclusive their top projections. On the right side the chrominance″ side projection is shown. The luminance contributions of the linear RGB input signals are represented by the start of the arrows and correspond with the EBU ones i.e. the EBU luminance contributions are:
Y_{R}:Y_{G}:Y_{B}=0.222:0.707:0.071.

The results of this EBU side projection can be compared with the ones according to the FCC (Federal Communications Commission) in the previous FIG. 8. It is to be noticed that again only the reference points of level 4 are shown.

2.3 The 3D Color Reproduction of an LCD as Function of the Saturation Control

The previous sections concerned signals offered to an arbitrary type of display as a function of a saturation increase. In case of a CRT display the only requirement is that the reach of the CRT drivers is large enough to handle the increased RGBmax′-signal amplitude as a function of the maximum chosen value of the saturation user control by the TV setmaker. One can imagine that if the saturation control has been adjusted to 1.5, the RGBmax′ and the relative RGBmax″ value will become large: respectively 1.443 and 2.324 for a blue color for which B=1 and R=G=0. The value of 2.324 also means that the blue light output will increase 2.324 times.

For a PDP, which has a linear transfer, the CRT transfer is imitated by a Look-Up-Table (LUT) before offering the color signals to the PDP drivers. Here the requirement is that the reach of the LUT (Look-Up-Table) and the PDP drivers correspond with the maximum RGBmax′-signal as a function of the maximum user saturation control. If the electronic circuitry and drivers of a CRT and PDP fulfill this requirement then the results in section 2.1 (with relation to RGBmax″) and section 2.2 (Y″) are valid.

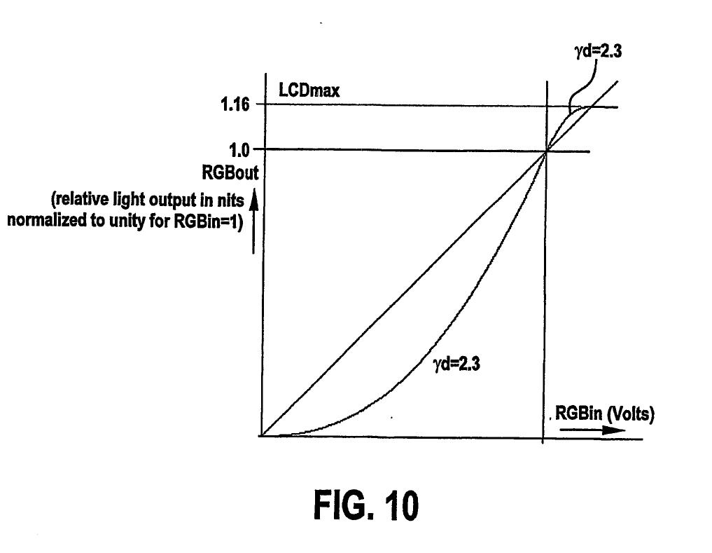

The transfer characteristic of an LCD however has a limited reach. In FIG. 10 an example is shown of an LCD transfer characteristic according the following equation:

$$if RGBin <= 1.0 then … RGBout = 1 \text{,} 0 \times {RGBin}^{γ d} else if RGBin <= LCD max then … RGBout = LCD max - ( LCD max - 1 \text{,} 0 ) \times {( \frac{LCD max - RGBin}{LCD max - 1 \text{,} 0} )}^{γ d} else … RGBout = LCD max \qquad ( 1 )$$

For RGBin<=1.0 Volts the LCD transfer characteristic is identical to the one of the CRT. The relative RGB light output (RGBout) is normalized to unity nits for RGBin=1.0 Volt. The LCDmax parameter is the relative maximum light output of the three RGB primaries and is supposed to be here 1.16. The exponent d in equation (1) is equal to the gamma value of the CRT, being 2.3.

Although an LCD has different transfer characteristics with a much larger gamma than 2.3 for each primary, it is supposed in this context that by means of three RGB LUT's the characteristics are matched to a gamma of 2.3 according FIG. 10. It is to be noticed that the upper part of the LCD transfer has become an exponential power function with an exponent of 2.3 as well.

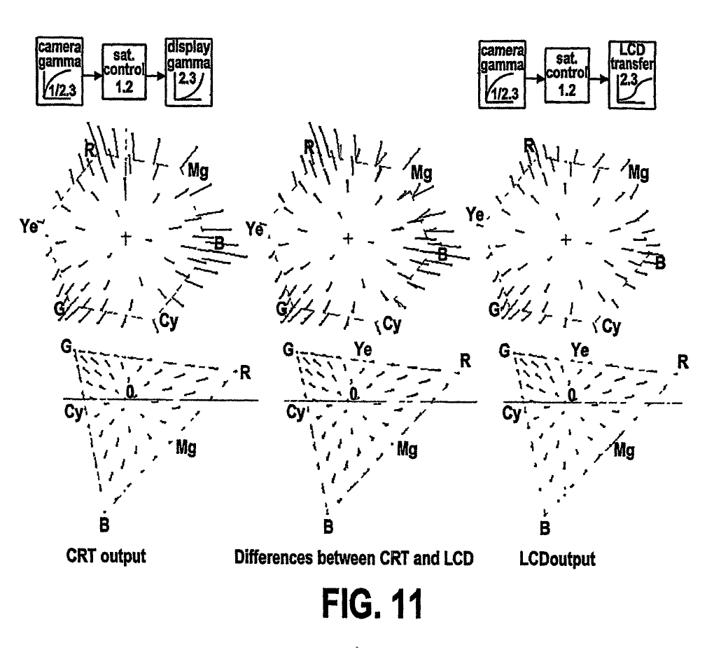

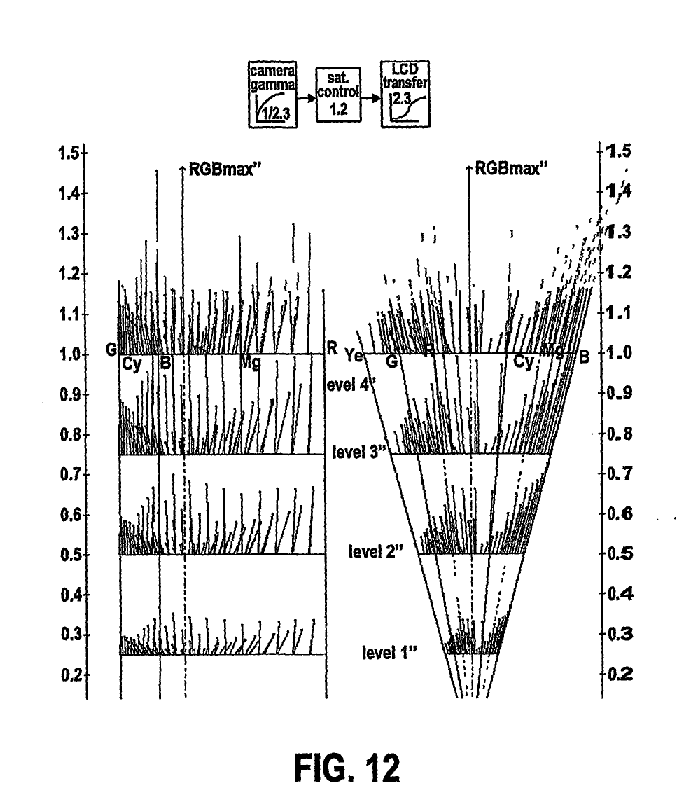

In FIG. 11 the differences are shown between the CRT and LCD output in the 2D UCS1976 and chrominance″ color planes. On the left side the CRT output is shown and on the right side the LCD output for a saturation control of 1.2. In the middle both are shown within a single viewgraph. Striking is that inside the UCS1976 color gamut and the chrominance″ hexagon the differences in color reproduction are small, i.e. small hue errors towards the borders in the cyan, blue, magenta and red area. At the borders however, especially between the cyan, blue, magenta and red border colors, small and also large hue errors occur. The reduction in the size of the LCD border color vectors in FIG. 11 are caused by the top of the LCD transfer curve and will be further explained with the aid of the FIG. 12.

The side projection of the relative RGBmax″ output of the LCD after a saturation control of 1.2 is shown in FIG. 12. When comparing this figure with the equivalent CRT output in FIG. 4 then can be seen that only at level 4″ the arrows have become much smaller. They have been compressed and have lost a lot of details. Even on the blue side of level 3″ there are some colors that are reduced in their RGBmax″ amplitude. All other arrows on level 1″,2″ and 3″ are the very same as those of FIG. 4. It is to be noticed that in FIG. 12 the linear input signals are used as reference input points. The conclusion is that at an increasing saturation control all LCD colors with an RGBmax″ value raising above level 4″ of the 3D color spaces do not have a proportional increase with all other colors below that level. Whether this loss of details from a perception point is acceptable or not is a different question that is not under discussion here.

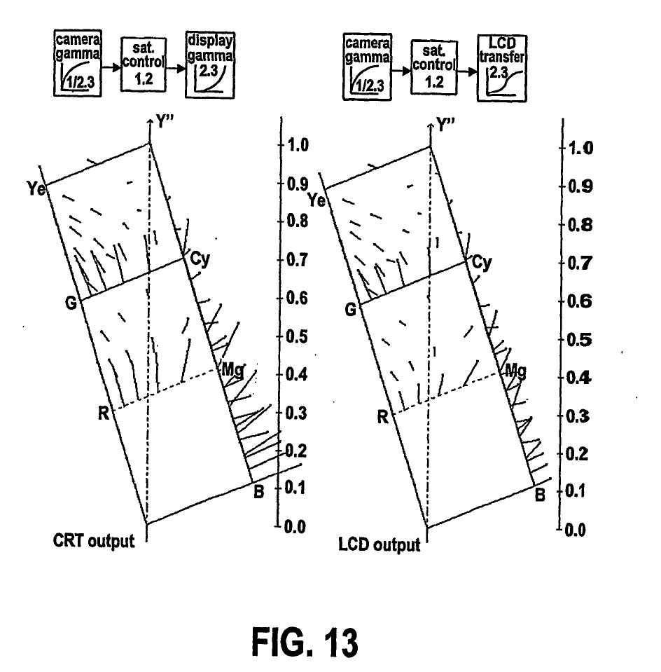

In the side projections of FIG. 13 the differences between the Y″ output of a CRT, on the left hand side, and an LCD, on the right hand side, can be seen after a saturation control of 1.2. It is to be noticed that only the reference points of level 4″ have been shown in FIG. 13. The luminance″ increase before and after the CRT display for the primary and complementary colors at a saturation control of respectively 1.2, 1.4 and 2.0 are shown in table 1. The calculations for an arbitrary saturation control can be done according to:
sat×(B′−Y′)+Y′

before the display, where B′ can be replaced by R′ and G′ where necessary. By taking the power of that result with an exponent of 2.3 the luminance″ output of the CRT display will be obtained i.e.:
(sat×(B′−Y′)+Y′)^{2.3}

TABLE 1
The relative amplitude before the CRT display and the relative luminance″ output
of the CRT display as a function of the saturation control, using Federal Communications
Commission (FCC) luminance contributions:

| | | before | before | before | Y″ output | Y″ output | Y″ output |
|---|---|---|---|---|---|---|---|
| | | display | display | display | of display | of display | of display |
| color | RGB input | sat = 1.2 | sat = 1.4 | sat = 2.0 | sat = 1.2 | sat = 1.4 | sat = 2.0 |
| blue | R = 0, G = 0, B = 0 | 1.1772 | 1.354 | 1.886 | 1.455 | 2.009 | 4.303 |
| red | R = 1, G = 0, B = 0 | 1.140 | 1.280 | 1.701 | 1.352 | 1.766 | 3.393 |
| magenta | R = 1, G = 0, B = 1 | 1.117 | 1.235 | 1.587 | 1.290 | 1.624 | 2.893 |
| green | R = 0, G = 1, B = 0 | 1.083 | 1.166 | 1.413 | 1.200 | 1.421 | 2.215 |
| cyan | R = 0, G = 1, B = 1 | 1.060 | 1.120 | 1.299 | 1.143 | 1.300 | 1.825 |
| yellow | R = 1, G = 1, B = 0 | 1.023 | 1.046 | 1.114 | 1.053 | 1.108 | 1.282 |

3. Maintenance of the Luminance Output of the Display as Function of the Color Saturation Control

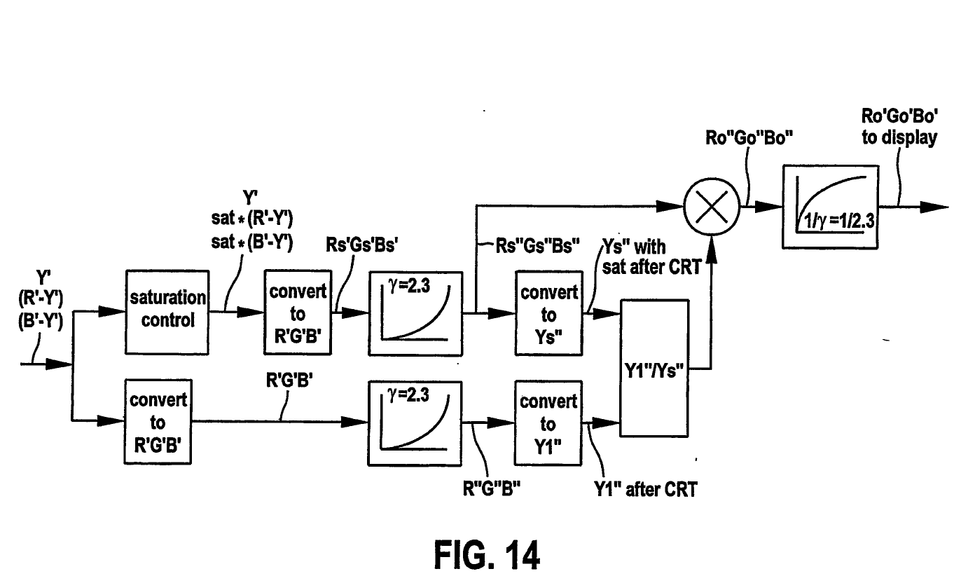

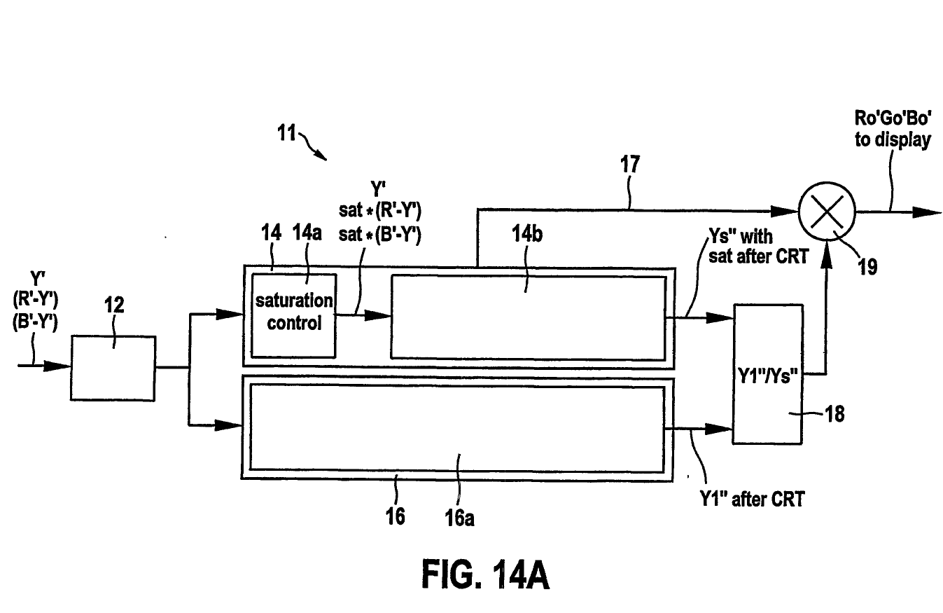

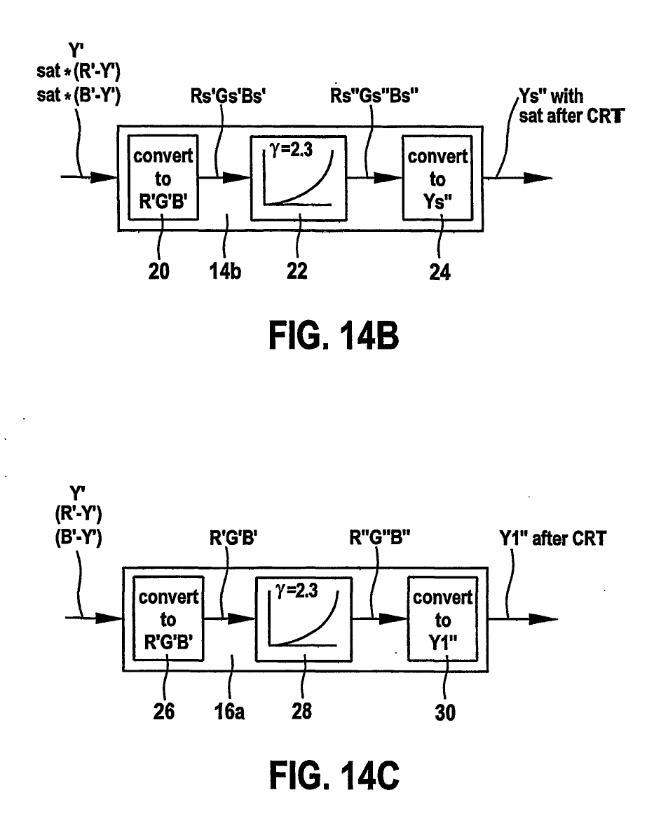

As proposed in section 2.2 a true saturation parameter should maintain the luminance output of the display. This can be obtained with a luminance control apparatus shown as a block diagram in FIG. 14.

The non-linear camera signals Luma Y′ and the color difference signals (R′−Y′) and (B′−Y′) are offered to the saturation control and respectively become Y′ and {sat×(R′−Y′)} and {sat×(R′−Y′)}. The Luma and color difference signals as well with and without a modified saturation control are converted to primary color signals, i.e. the R′G′B′ signals of the camera and the Rs′Gs′Bs′ signals with a modified saturation control. The notation “s” in the Rs′Gs′Bs′ signals indicate the modified saturation control.
R′=(R′−Y′)+Y′
G′=(G′−Y′)+Y′,
where
(G′−Y′)=−(Y_{R}/Y_{G})×(G′−Y′)−(Y_{B}/Y_{G})*(G′−Y′)
B′=(B′−Y′)+Y′ (2)

The Y_{R}, Y_{G} and Y_{B} luminance contributions for obtaining the (G′−Y′) signal are according the FCC standard, which is used for the transmission of the Luma signal Y′ and the color difference signals

(R′−Y′) and (B′−Y′). So the relation holds:
Y_{R}:Y_{G}:Y_{B}=0.299:0.587:0.114.
For the Rs′Gs′Bs′ signals the relation holds:
Rs′=sat×(R′−Y′)+Y′
Gs′=sat×(G′−Y′)+Y′
Bs′=sat×(B′−Y′)+Y′, (3)
the (G′−Y′) signal of the previously obtained G′ signal can be used. Both signal streams, the R′G′B′ and the Rs′Gs′Bs′ one, are offered to two LUTs containing the CRT transfer function. This results in the R″G″B″ signals representing the CRT output without modified saturation control and the Rs″Gs″Bs″ signals inclusive it.
R″=R′^{γ}, G″=G′^{γ}, B″=B′^{γ}
and
Rs″=Rs′^{γ}, Gs″=Gs′^{γ}, Bs″=Bs′^{γ} (4)

In the case a display type has been used with another transfer characteristic than the one of a standard CRT with γd=2.3, for example an LCD or PDP, then it should still be necessary to apply the CRT transfer curve because every type of display has to be in conformity with the CRT transfer characteristic. In section 2 it has been explained that the RGBmax′ and RGBmax″ amplitudes can significantly increase as a function of the maximum amount saturation increase defined by the TV setmaker. This reach of the RGBmax′ and RGBmax″ increase should be taken into account in the two CRT LUT's. At least it should be taken into account in the one processing the modified saturation control.

For the conversion of the R″G″B″ and the Rs″Gs″Bs″ signals to respectively the Y1″ and Ys″ luminance signals it is necessary to apply the luminance contributions of the concerned display, otherwise the maintenance of the luminance output of the display as described here will fail. The Y1″ signal represents the original luminance output of the display for a saturation control of 1.0, while the Ys″ signal concerns the luminance output of the display with a modified saturation control, being an increase or decrease. I.e. for the conversion to the luminance signals Y1″ and Ys″ the relation holds:
Y1″=Y_{Rdisplay}×R″+Y_{Gdisplay}×G″+Y_{Bdisplay}×B″
Ys″=Y_{Rdisplay}×Rs″+Y_{Gdisplay}×Gs″+Y_{Bdisplay}×Bs″, (5)
where Y_{Rdisplay}, Y_{Gdisplay} and Y_{Bdisplay} represent the luminance contributions of the display i.e. a CRT, LCD or PDP display. The notation of the predicted display output of the original input signal is Y1 where “1” has been chosen to indicate the unity saturation control.

In order to maintain the final luminance output of the display the Rs″Gs″Bs″ signals have to be multiplied with the quotient of the Y1″ signal and the Ys″ signal. So:
Ro″=Rs″×Y1″/Ys″
Go″=Gs″×Y1″/Ys″
Bo″=Bs″×Y1″/Ys″ (6)

By undoing the previously CRT gamma on the Ro″Go″Bo″ signals the Ro′Go′Bo′ signals are achieved which can be used as input signals for the display.
Ro′=Ro″^{1/γ}, Go′=Go″^{1/γ}, Bo′=Bo″^{1/γ} (7)

After the display, being a CRT, LCD, PDP or whatever other type with the transfer characteristic of the CRT as the standard, its output will correspond with: (Ro″^{1/γ})^{γ}=Ro″ and on a similar way to Go″ and Bo″. Neglecting a constant between the input and output of the display, it is supposed to be unity, this means that the luminance output of the display expressed in cd/m² corresponds with:

$${Y}^{″} = {Y}_{Rdisplay} \times {Ro}^{″} + {Y}_{Gdisplay} \times {Go}^{″} + {Y}_{Bdisplay} \times {Bo}^{″} = {Y}_{Rdisplay} \times {Rs}^{″} \times Y {1}^{″} / {Ys}^{″} + {Y}_{Gdisplay} \times {Gs}^{″} \times Y {1}^{″} / {Ys}^{″} + {Y}_{Bdisplay} \times {Bs}^{″} \times Y {1}^{″} / {Ys}^{″} = Y {1}^{″} \times ( {Y}_{Rdisplay} \times {Rs}^{″} + {Y}_{Gdisplay} \times {Gs}^{″} + {Y}_{Bdisplay} \times {Bs}^{″} ) / {Ys}^{″} = Y {1}^{″}$$

$$because ( {Y}_{Rdisplay} \times {Rs}^{″} + {Y}_{Gdisplay} \times {Gs}^{″} + {Y}_{Bdisplay} \times {Bs}^{″} ) = {Ys}^{″}$$

Consequently the output of the display after a modification of the saturation control is the very same as the one with a saturation control of 1.0.

With regard to the apparatus a particular preferred embodiment is formed as a device comprising an interconnected circuit of particular kind or other kind of preferable circuitry adapted to execute the method as outlined above. Such device may be incorporated in a means for receiving the original signal and displaying the image by the display signal. For instance such device may be incorporated in a television system or directly in a CRT, LCD or PDP-display. Consequently such apparatus also has to be understood to be formed by an imaging system 1 as described in detail with regard to FIG. 1.

Of course the device may be arranged throughout the imaging system 1 of FIG. 1 in any preferable way. In particular a mentioned device or interconnected circuit of particular kind or other kind of preferable circuitry may be incorporated in a register means 2 (FIG. 1), like a camera or other kind of pick up device for scanning an image. Also such device may be incorporated in a transfer means 5 (FIG. 1) like a NTSC or PAL transmission. Most preferably a mentioned device may be incorporated in a display means 9 (FIG. 1) like a CRT, LCD or PDP display or a printer of any desired kind.

FIG. 14a shows in principle the main parts of a device 11 as a preferred embodiment of the luminance control apparatus for controlling the luminance. Such device is in particular adapted to execute the method as outlined above and to achieve the advantages thereof.

The device 11 comprises:
an input means 12 for providing an original image signal (Y′, R′−Y′, B′−Y′) having a luminance component Y′ and a color component R′−Y′, B′−Y′ to a first processing stream 14 and a second processing stream 16.

The first processing stream 14 comprises:
a control means 14a for applying a saturation control to the original image signal (Y′, R′−Y′, B′−Y′) resulting in a saturation controlled image signal (Y′, sat*(R′−Y′), sat*(B′−Y′)), and
a first prediction means 14b for predicting a first predicted image signal (Ys″, Rs″−Ys″, Bs″−Ys″) by further processing thereof.

The second processing stream 16 comprises:
a second prediction means 16a for predicting a second predicted image signal (Y1″, R1″−Y1″, B1″−Y1″) by processing of the original image signal (Y′, R′−Y′, B′−Y′).

Furthermore the device 11 comprises a comparator means 18 for providing a correction factor Y1″/Ys″ and comparing the luminance Ys″ of the first predicted image signal (Ys″, Rs″−Ys″, Bs″−Ys″) to the luminance Y1″ of the second predicted image signal (Y1″, R1″−Y1″, B1″−Y1″).

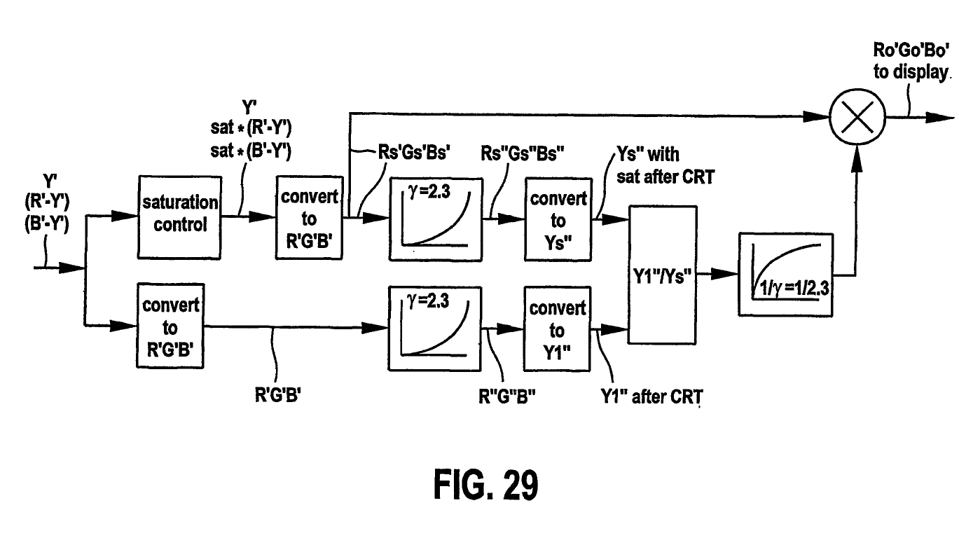

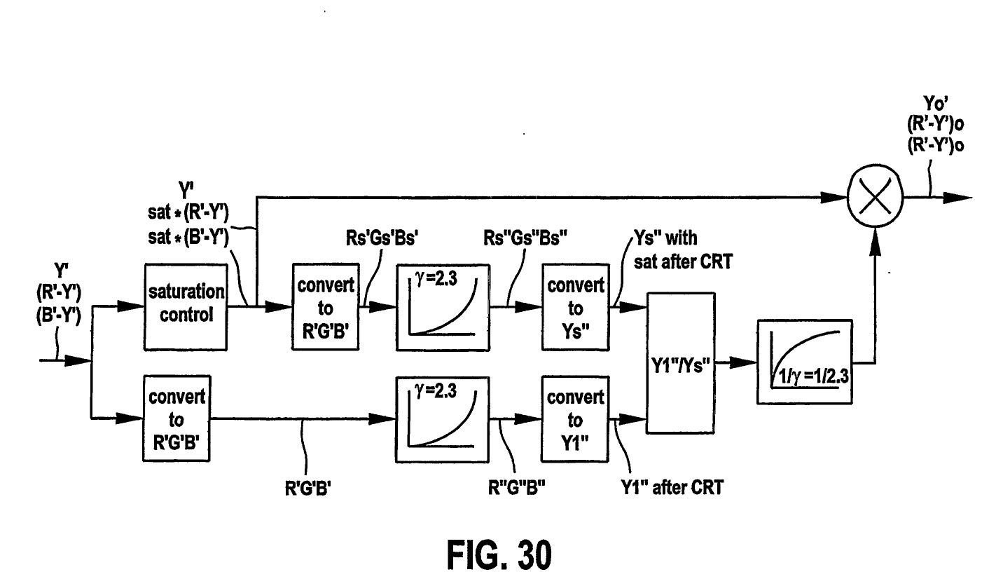

Also the device 11 comprises an operator means 19 for applying the correction factor Y1″/Ys″ to correct one of the image signals 17 of the first processing stream 14 to give a display signal (Ro′, Go′, Bo′). The mentioned operator means 19 may be realized in several ways and may incorporate various operations. E.g. various kinds of image signals 17 of the first processing stream 14 may be used. Also various possibilities exist to apply a gamma-conversion or inverse gamma-conversion. Some of these several ways are shown with regard to modifications of the method and explained in detail further down with regard to FIG. 29 and 30.

In a particular preferred configuration the device 11 comprises in the first processing stream 14:
a control means 14a for applying a saturation control to the original image signal (Y′, R′−Y′, B′−Y′) resulting in a saturation controlled image signal (Y′, sat*(R′−Y′), sat*(B′−Y′)), and a first prediction means 14b for predicting a first predicted image signal (Ys″, Rs″−Ys″, Bs″−Ys″).

The first prediction means 14b is shown in detail in FIG. 14b. The prediction means 14b comprises suitable components indicated in FIG. 14b for:
converting 20 the saturation controlled image signal (Y′, sat*(R′Y′), sat*(B′−Y′)) into a first saturation controlled RGB-image signal (Rs′, Gs′, Bs′) having a saturation controlled red Rs′, green Gs′ and blue Bs′ color component,
gamma-converting 22 the first saturation controlled RGB-image signal (Rs′, Gs′, Bs′) into a second saturation controlled RGB-image signal (Rs″, Gs″, Bs″), and
converting 24 the second saturation controlled RGB-image signal (Rs″, Gs″, Bs″) into the first predicted image signal (Ys″, Rs″−Ys″, Bs″−Ys″).

In a particular preferred configuration the device 11 comprises in the second processing stream 16:
a second prediction means 16a for predicting a second predicted image signal (Y1″, R1″−Y1″, B1″−Y1″).

The second prediction means 16a is shown in detail in FIG. 14c. The prediction means 16a comprises suitable components indicated in FIG. 14c for:
converting 26 the original image signal (Y′, R′−Y′, B′−Y′) into a first RGB-image signal (R′, G′, B′) having a red R′, green G′ and blue B′ color component,
gamma-converting 28 the first RGB-image signal (R′, G′, B′) into a second RGB-image signal (R″, G″, B″), and
converting 30 the second RGB-image signal (R″, G″, B″) into the second predicted image signal (Y1″, R1″−Y1″, B1″−Y1″).

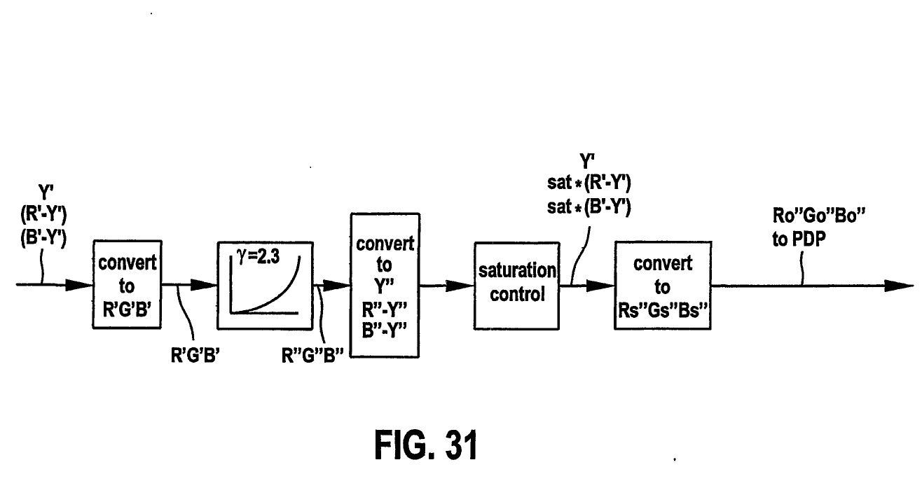

The device as described in FIG. 14a, 14b and 14c may be adapted with regard to further modifications of the method. The further modifications and its advantages will be described in detail further down with reference to FIG. 31, 33, 35 and 37.

3.1 Luminance Output Maintenance at an Increasing Saturation Control

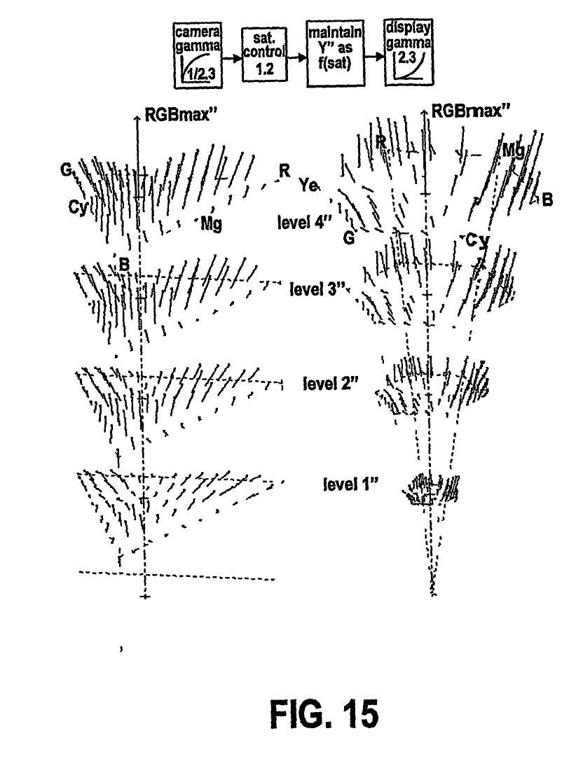

For a saturation control of 1.2 in FIG. 15 the result of the maintenance of the CRT luminance output is shown in the 3D UCS1976 and chrominance′″ space with RGBmax″ as vertical dimension. For being able to compare FIG. 15 with FIG. 3 here an FCC camera and CRT display system is shown. Although in the processing flow of this figure a ‘constant Y″ is mentioned as f(sat)’ the notation “constant luminance” is not to be taken literally as the luminance as a function of the saturation control is not constant in this proposed concept and cannot be compared with a constant luminance aspect of the colorimetry.

It can be seen that independent of the level the RGBmax″ output of the primary and complementary colors is maintained to the level with a saturation control of 1.0. All other reference points have an increased RGBmax″ CRT output, but of course with maintenance of the luminance Y″ output.

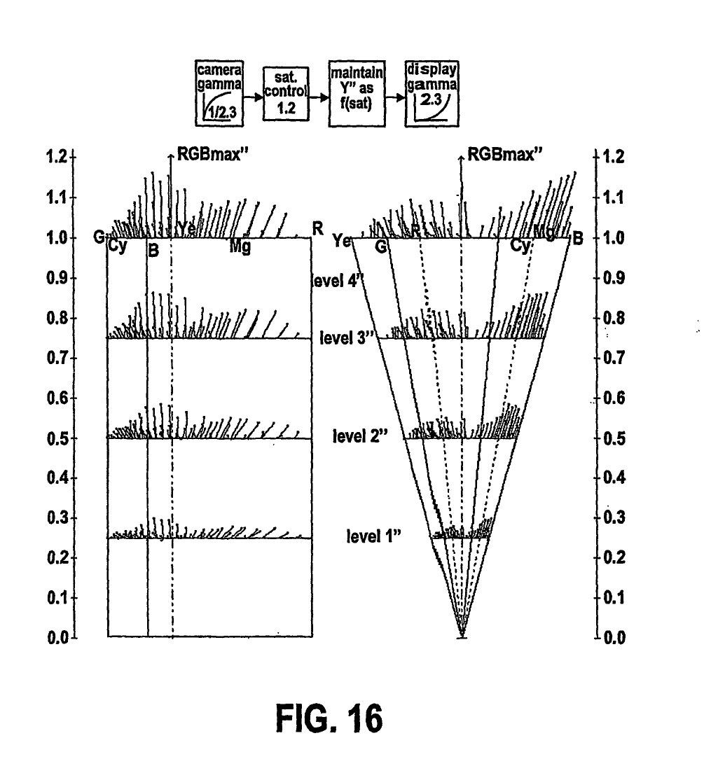

In FIG. 16 the side projection of FIG. 15 is shown, which gives a better impression of the increase of RGBmax″ output when maintaining the luminance output of the display for a saturation control of 1.2.

The increase of the RGBmax″ output in the FIGS. 15 and 16 means that the luminance output of the corresponding primary display color will increase as well. Because the total luminance output of the display is maintained the other two primaries should have a decreasing luminance contribution which has to be equal to the increasing luminance of the display primary corresponding with RGBmax″.

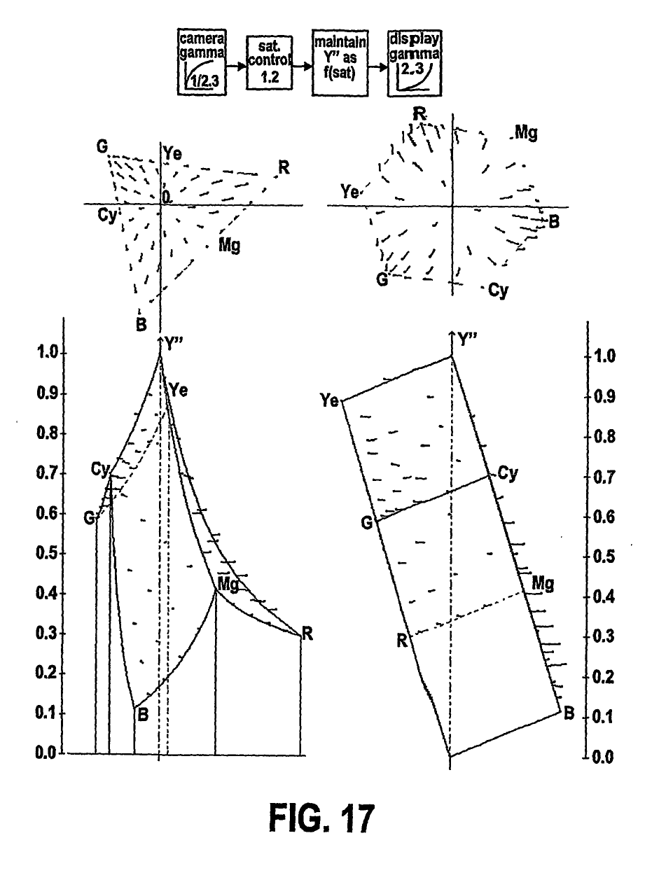

That this is true can of course be calculated, but a better proof gives FIG. 17 by showing the side projection of the luminance output of the display for 67 reference points at level 4″ after an increase of the color saturation of 20%. By the horizontal arrows clearly can be seen that the luminance output of the display has been maintained. At the top of FIG. 17 the 2D color reproduction, i.e. the top projection, is shown. When comparing these results with the on in FIG. 2 those 2D results show almost the same saturation increase for the colors lying within the UCS1976 gamut or the Chrominance″ hexagon. The maintenance of the luminance output of the display in FIG. 15 shows a small decrease in color saturation towards the borders. It holds for the border colors in the hexagon that they have decreased dramatically. Due to a much smaller RGBmax″ increase the effect of the 3D cone is much less, moreover their hue is almost maintained.

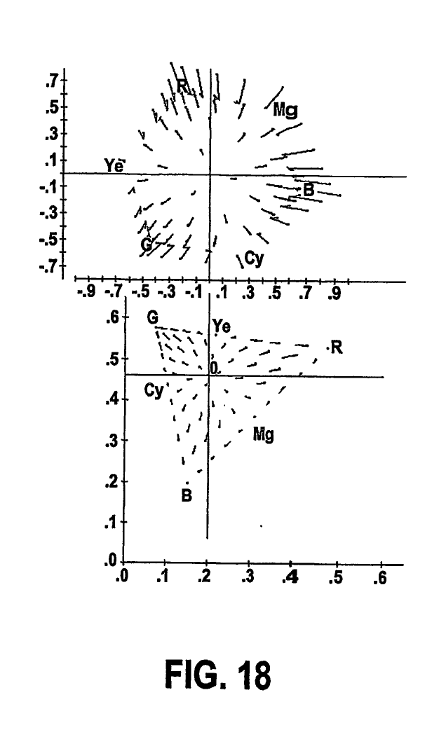

In FIG. 18 those differences can be seen very clearly because the 2D color reproduction without maintenance (lines at the outer periphery of the hexagon) and with maintenance (lines within the hexagon) of the luminance output of the display are shown.

3.2 Luminance Output Maintenance at a Decreasing Saturation Control

For developing color improvement algorithms a lower (local) saturation control value can be as important as a higher one. “Local” saturation control means that the saturation has been modified for very specific colors. Therefore the analysis of a reduction of the saturation control will be thoroughly explained. In the next six FIGS., 19 to 24, those having the numbers 19, 21 and 23 show the color reproduction with a conventional decreasing saturation control, and those having the numbers 20,22 and 24 show the results of the same reduction of the saturation control but then with maintenance of the luminance″ output of the display.

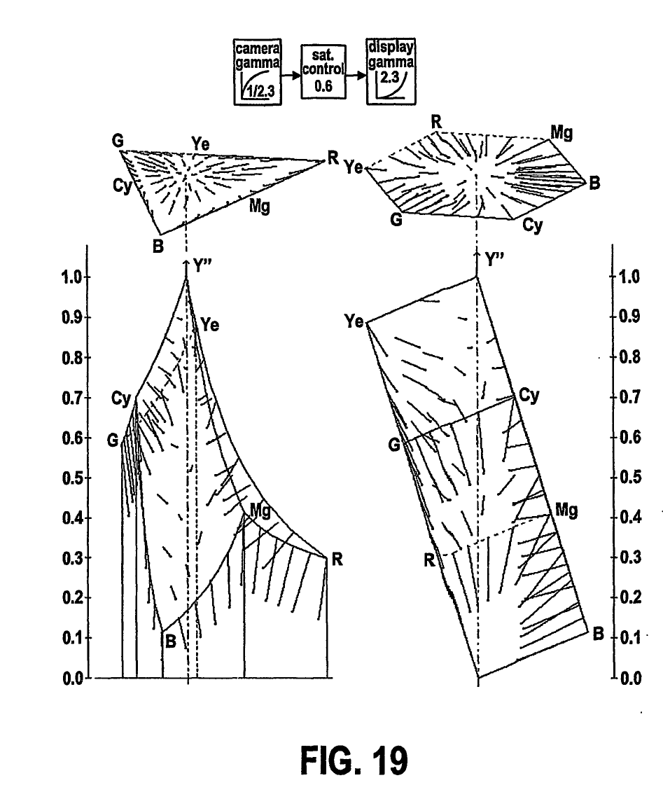

For being able to compare the figures in this section with the one in previous sections, the FCC instead of EBU luminance contributions are used for the output of the display. The side and top projection in the UCS1976 and Chrominance″ space in FIG. 19 show both the luminance″ (side) and the color reproduction of the conventional way of reducing the saturation control to 0.6. As has been shown in FIG. 8 with an increased saturation control of 1.2, also here the change in the luminance″ output of the display is relatively large. For a blue color with B=1, R=G=0, the display output reduces from 0.114 to 0.043 cd/m² given 1 cd/m² as a reference for R=G=B=1.0 Volt.

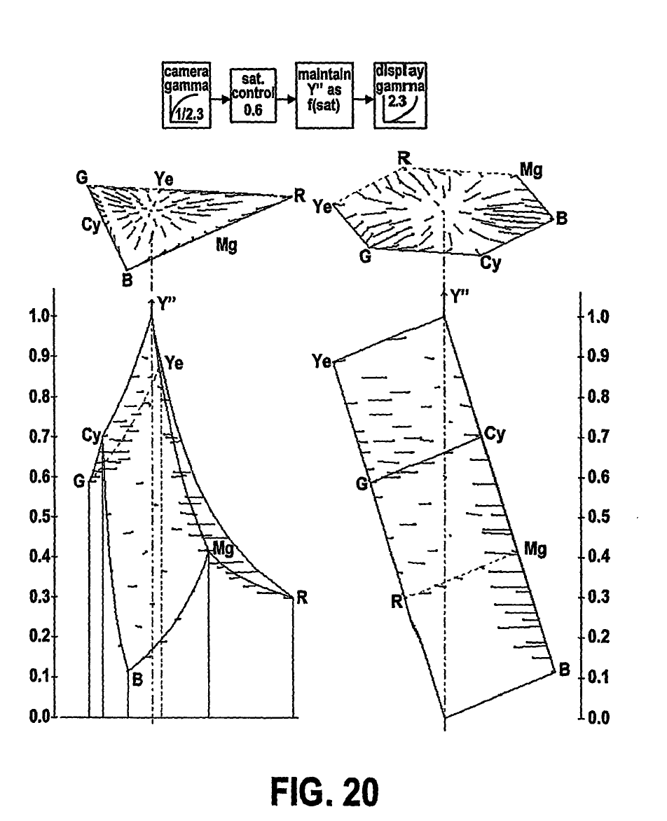

In FIG. 20 the color reproduction is shown with maintenance of the luminance″ output of the display and a saturation control of 0.6. When comparing the UCS1976 top projections of the FIGS. 19 and 20 then there are no differences. The final u′v′-coordinates of figures are the same. The Chrominance″ top projections are however different due to the differences in the luminance″ output and the 3D cone shape of the Chrominance″ space, here with Y″ as vertical dimension. It is to be noticed that the chrominance″ top projection with RGBmax″ as vertical dimension is the very same as those shown with Y″ as vertical dimension in the FIGS. 19 and 20, but also 21 and 22, as well as 23 and 24. In those 2D planes the actual 3D cone shape would have been mentioned as one of the causes for the differences in the Chrominance″ top projections.

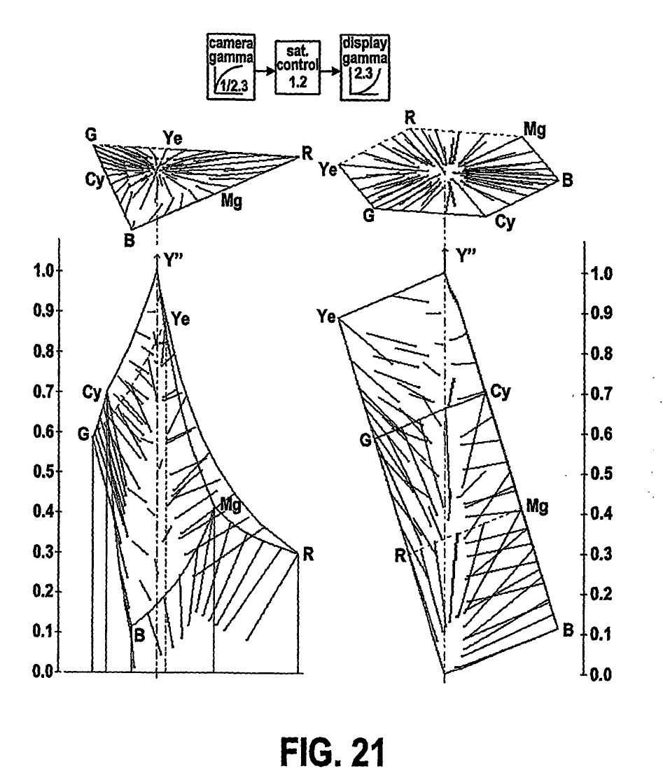

In FIG. 21 the side and top projection of the display output are shown with a saturation control of 0.3. For a blue color with B=1, R=G=0, the display output reduces now from 0.114 to 0.016 cd/m². It is to be noticed that the “luminance” output of the display for red, magenta and blue colors relatively decreases quite much.

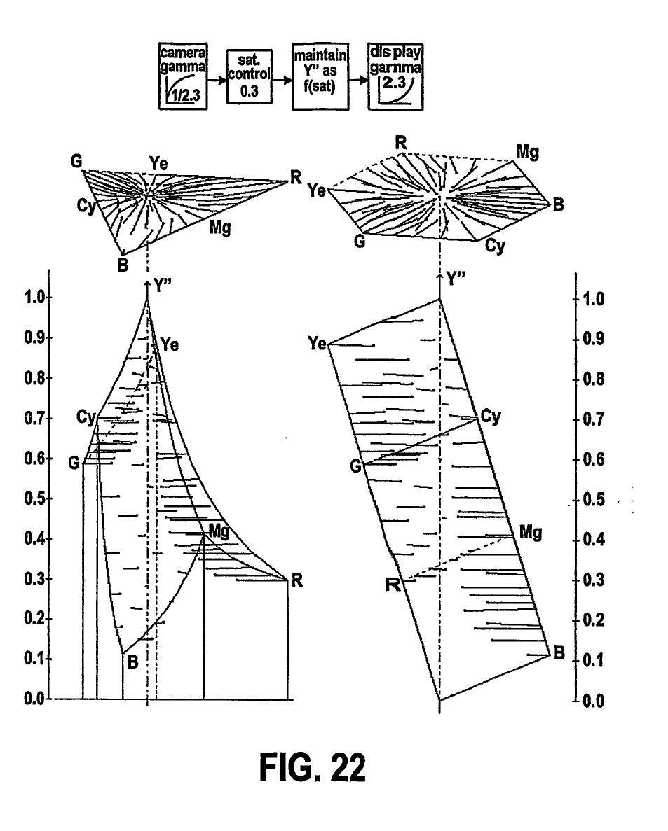

With the circuitry for maintaining of the luminance″ output of the display output as shown in FIG. 22 the luminance″ remains unchanged with a saturation control going to 0.3. Also here the top projections of the UCS1976 spaces of FIG. 21 and 22 are the very same while the “chrominance” top projections differ for the same reason as described here above.

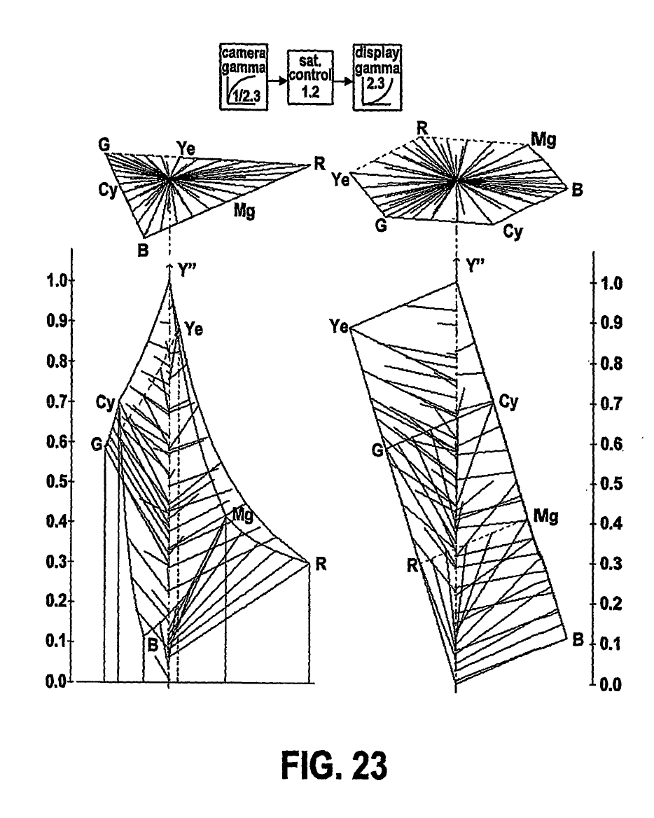

With the saturation control at 0.0 an original color picture has become a “black&white” picture. In FIG. 23 all 67 reference points have shifted to the gray line in the centre of the color space. For a blue color with B=1, R=G=0, the display output reduces now from 0.114 to 0.007 cd/m², being a light output reduction of almost 17 times, as indicated already by the above calculation.

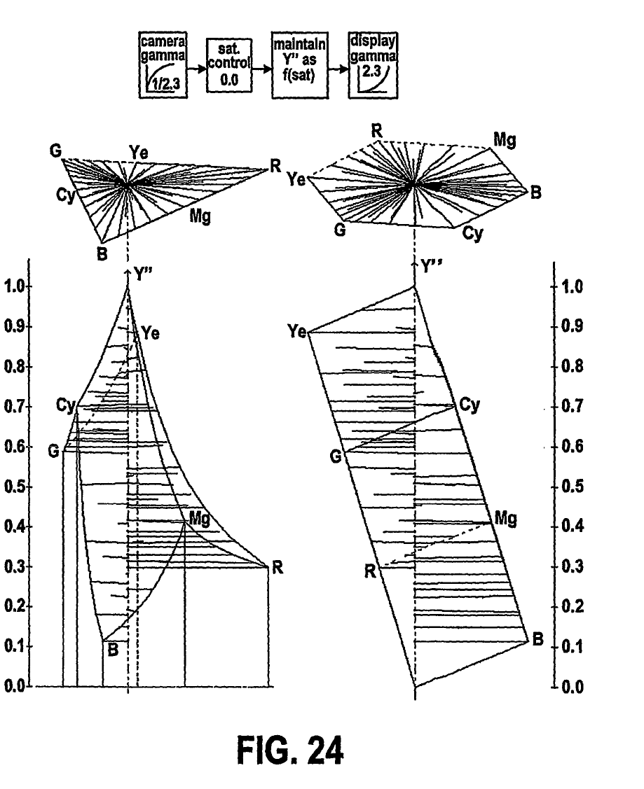

When maintaining the luminance″ output of the display output as shown in FIG. 24 the luminance″ of all colors remains unchanged with a saturation control going to 0.0. Also here the top projections of the UCS1976 spaces of FIG. 23 and 24 are the very same. In this particular case of a saturation control of 0.0, also the Chrominance″ top projections of FIG. 23 and 24 are the same. The other particular case that this happens is when the saturation control is 1.0. For a blue color, B=1, R=G=0, and a saturation control of 0.0 the display output remains 0.114 cd/m². The calculation of the light output of a blue input color for with B=1 and R=G=0 and a saturation control of 0.0 without and with luminance″ maintenance. For a saturation control of 1.0, which light output is used for luminance″ maintenance, counts that B′=1 and R′=G′=0. With the saturation control set to zero counts that: Rs′=Gs′=Bs′=Y′, the conventional way of saturation control, so without luminance″ maintenance.

The R′G′B′ and Rs′Gs′Bs′ signals are offered to the CRT LUTs as explained in FIG. 14. So B″=1 and R″=G″=0, resulting in a light output of Y1″=Y_{Bdisplay}×B″=Y_{Bdisplay} (for sat=1.0) or 0.114 cd/m² in case of a display with FCC color primaries (FIG. 24). In case of an EBU display this is 0.07 cd/m². For the signal stream with sat=0.0 counts that Rs″=Gs″=Bs″=Y″.

The light output Ys″ becomes: Ys″=Y_{Rdisplay}×Y″+Y_{Gdisplay}×Y″+Y_{Bdisplay}×Y″=Y″ because Y_{Rdisplay}+Y_{Gdisplay}+Y_{Bdisplay}=1.

For the light output Ys″one may write: Ys″=Y″=(Y_{Bdisplay})^{γ=(}0.114)^{2.3}=0.007 cd/m² for an FCC display (FIG. 23) and (0.07)²³=0.002 cd/m² for an EBU display. When maintaining the final luminance output of the display the Rs″Gs″Bs″ signals have to be multiplied with the quotient of the Y1″ and Ys″ signal (FIG. 14) i.e.:
Ro″=Y″×Y_{Bdisplay}/Y″=Y_{Bdisplay}
Go″=Y″×Y_{Bdisplay}/Y″=Y_{Bdisplay}
Bo″=Y″×Y_{Bdisplay}/Y″=Y_{Bdisplay}

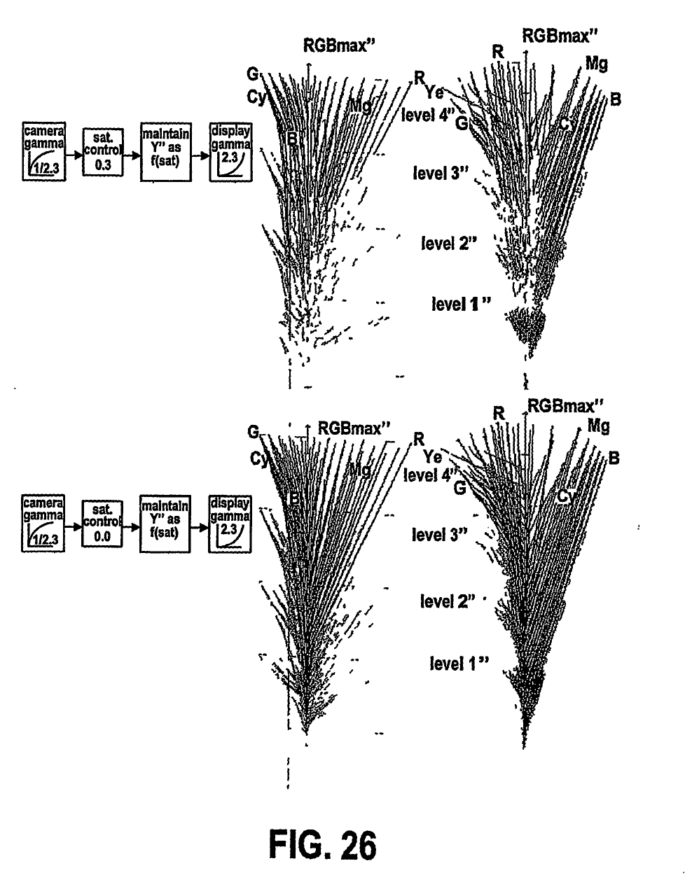

Undoing the CRT gamma on the Ro″Go″Bo″ signals (FIG. 14) and redoing it again by the display results in a light output Ro=Go=Bo=Y_{Bdisplay} with as a consequence that RGBmax″=Y_{Bdisplay}. So the relative RGBmax″ output of 1.0 at a saturation control of 1.0 has been lowered to a value of Y_{Bdisplay} at a saturation control of 0.0 as indicated in the lower part of FIG. 26. For the same three conditions as shown before, i.e. a saturation control of 0.6, 0.3 and 0.0, the analysis is shown of the maintenance of the luminance″ output of the display in the UCS1976 and Chrominance″ color spaces with RGBmax″ as the vertical dimension.

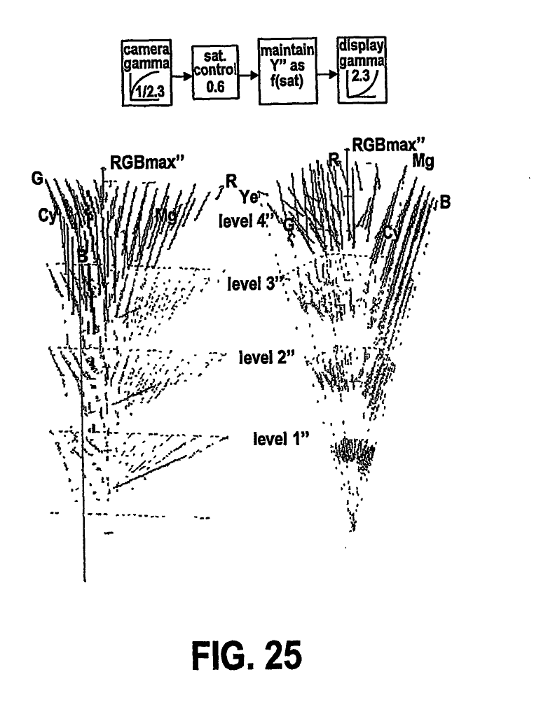

In FIG. 25 the results are shown for a saturation control of 0.6. It might perhaps be somewhat confusing that, when the luminance″ output of the display is maintained, the RGBmax″ value decreases at a decreasing saturation control. One has to realize however that a decrease of RGBmax″ concerns one of the three primary colors, while the luminance″ output concerns the luminance contribution of the three primaries together. An RGBmax″ decrease of a primary color means that also the light output of that primary color will decrease proportionally. At a decreasing saturation and maintenance of the luminance output this means that the luminance contribution of the other two primaries has to increase. At a saturation control of 0.3 and 0.0, as shown in FIG. 26, the RGBmax″ color starts decreasing relatively very much. It is important to apply sufficient bits for the calculations. In case of an 8 bit processing quantization errors will occur. Starting with 8 bits and a calculation with reals will not cause visible quantization errors. At least 12 bits or more are needed in order to avoid visible quantization at saturation controls of 0.1-0.4.

3.3 Luminance Output Maintenance at an Increasing Saturation Control for LCD

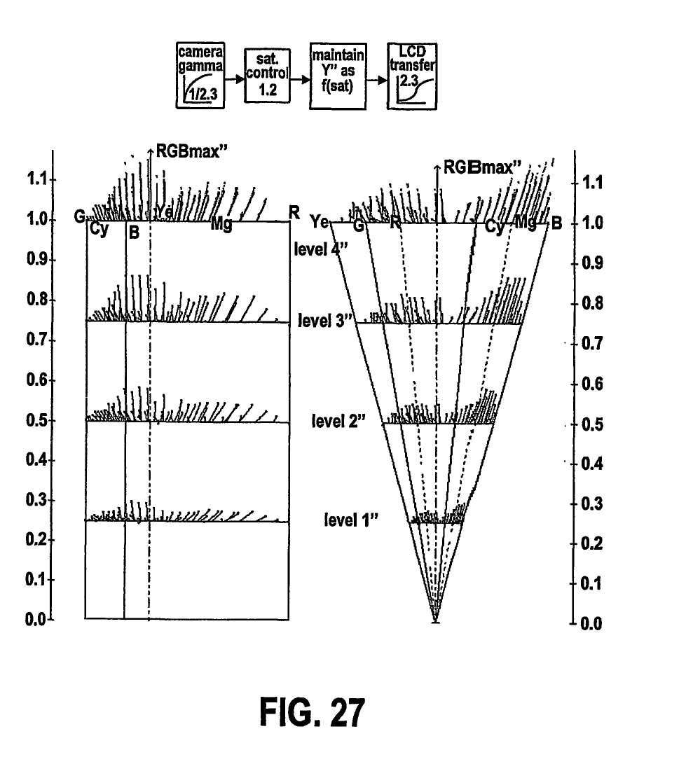

In FIG. 27 the side projection of the color analysis is shown of an LCD according equation (1) is shown with maintenance of the luminance″ output as function of a saturation control of 1.2. In comparison with FIG. 16 the amount of compression is much less then without luminance″ maintenance as shown in FIG. 12 (for LCD) and 4 (for CRT). When simulating the LCD and CRT results on arbitrary pictures the differences can hardly or not be noticed, even at a larger saturation control of 1.4.

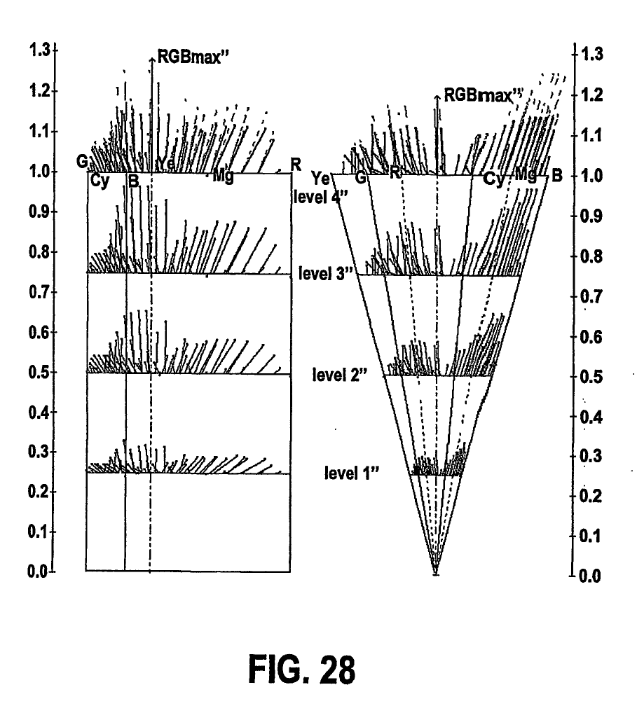

In FIG. 28 the results are shown of the luminance″ maintenance at a saturation control of 1.4 for a CRT (top) and an LCD (bottom). The differences have become larger but seem to be very acceptable in practice.

3.4 Luminance Output Maintenance as f(sat) with Less Processing in the Signal Path

For some applications it may be particular advantageous to minimize the processing steps in the signal paths or streams. In FIGS. 29 and 30 two variations of FIG. 14 are shown wherein the processing steps in the signal streams are reduced but nevertheless have the very same results.

In FIG. 14 the processing path for “luminance” maintenance consists of the saturation control, the conversion to Rs′Gs′Bs′ signals, the CRT LUTs, the multipliers and the inverse CRT LUTs. By means of a small reorganisation of the circuit diagram of FIG. 14 the two LUTs can be moved to the Ys″ calculation path as shown in FIG. 29. This also requires that the Y1″/Ys″ divider is acting on the inverse CRT LUT. The Ro′Go′Bo′ signals in FIG. 29 are the very same as those in FIG. 14. After the inverse CRT LUTs the step from equation (6) to (7) can be written as:
(Ro″)^{1/γ}=(Rs″×Y1″/Ys″)^{1/γ}
(Go″)^{1/γ}=(Gs″×Y1″/Ys″)^{1/γ}
(Bo″)^{1/γ}=(Bs″×Y1″/Ys″)^{1/γ}
Because (Ro″)^{1/γ}=Ro′ counts that:
Ro′=Rs′×(Y1″/Ys″)^{1/γ}
Go′=Gs′×(Y1″/Ys″)^{1/γ}
Bo′=Bs′×(Y1″/Ys″)^{1/γ} (8)

Equations (8) has literally been executed in FIG. 29.

In FIG. 30 is shown that it is also possible to maintain the Luma and color difference signals in the signal path. When converting the Y1′, (R′−Y′)o and (B′−Y′)o signals to RGB signals then the Ro′Go′Bo′ signals of FIG. 14 and 29 are obtained.
Yo′=Y′×(Y1″/Ys″)^{1/γ}
(R′−Y′)o=sat×(R′−Y′)×(Y1″/Ys″)^{1/γ}
(B′−Y′)o=sat×(B′−Y′)×(Y1″/Ys″)^{1/γ} (9)

Converting the Y′, sat×(R′−Y′) and sat×(B′−Y′) signals results in the Rs′Gs′Bs′ signals. Multiplying those signals with (Y1″/Ys″)^{1/γ} is according equation (8), i.e. it is also allowed to process the “luminance” maintenance as function of the saturation control with the Y′, sat×(R′−Y′) and sat×(B′−Y′) signals as shown in FIG. 30.

3.5 The Maintenance of the Luminance Output of a PDP

The concept of the present invention has major advantages. For instance the invention also works in the linear domain, for example for a PDP display or a linearized display matrix that incorporates the saturation as well. In a linear domain the luminance remains constant as a function of the saturation. For a PDP or a saturation control being combined with a linearized display matrix, however, usually there a problems because such a display cannot handle negative signal contributions.

The previous solutions also can be applied for a PDP so that the same electronic circuitry can be applied as for a CRT or LCD. Whether it has advantage or not is another question, but because of the linear transfer of a PDP it is possible to locate the saturation control after the CRT gamma simulation. Depending on the camera gamma and the simulated CRT gamma the overall transfer has become more linear, resulting in a much smaller amplitude increase after a saturation increase then in case it is located before the CRT. In FIG. 31 the processing diagram for a PDP is shown. The transmitted Luma and color difference signals are converted to the primary color signals, i.e. the R′G′B′ signals of the camera, just like mentioned in section 3 in equation (2).
R′=(R′−Y′)+Y′
G′=(G′−Y′)+Y′,
where
(G′−Y′)=−(Y_{R}/Y_{G})×(G′−Y′)−(Y_{B}/Y_{G})*(G′−Y′)
B′=(B′−Y′)+Y′

The YR, YG and YB luminance contributions are according the FCC transmission standard. After the simulation of the CRT gamma the output signals R″, G″and B″ are converted back to the luminance signal Y″ and the color difference signals R″−Y″ and B″−Y″ in order to make the saturation control possible. After the conversion to the Rs″, Gs″and Bs″signals for driving the PDP the relation holds:
Ro″=Rs″=sat×(R″−Y″)+Y″
Go″=Gs″=sat×(G″−Y″)+Y″
Bo″=Bs″=sat×(B″−Y″)+Y″

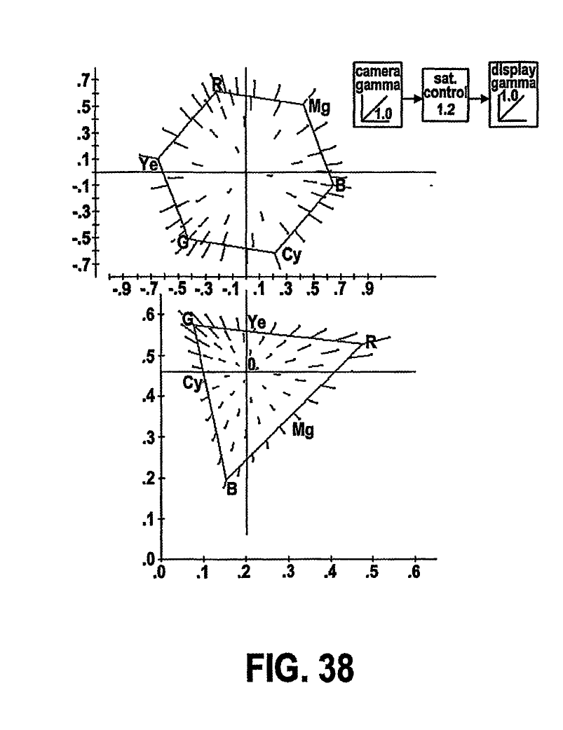

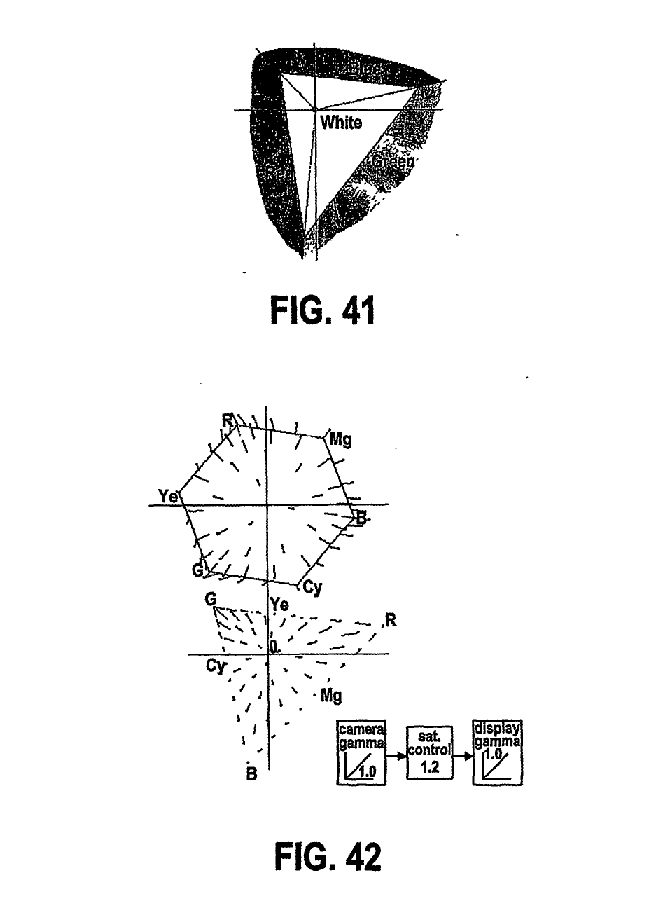

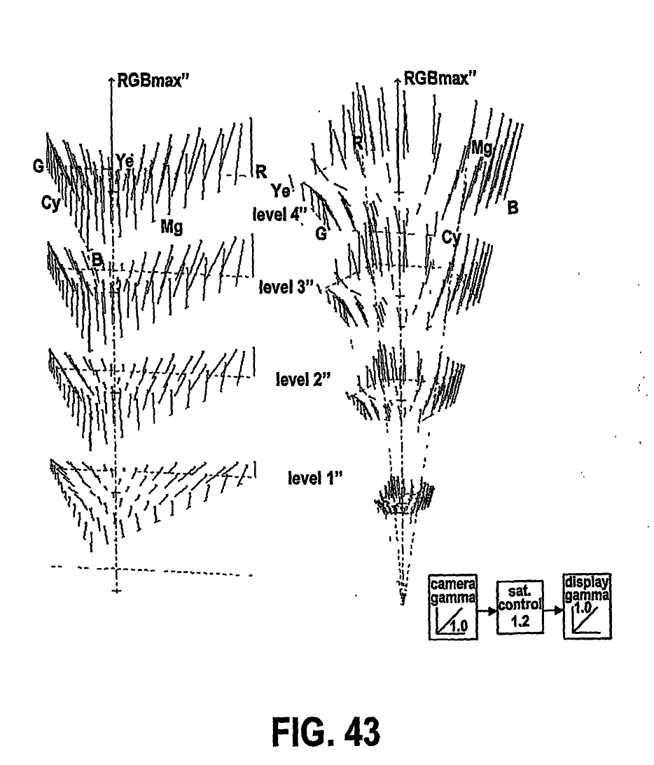

It has been taken for granted that the (G″−Y″) signal is also available when the R″G″B″ signals are converted to Y″, R″−Y″ and B″−Y″. Supposing that the gamma of the camera is inverse to the CRT one then after 20% increase of the saturation control the same color reproduction will be obtained as shown in the FIGS. 38 to 40 of the appendix and the FIGS. 5 and 6 of section 2.2. Because it is impossible to generate negative primary color contributions the final light output of the PDP will be according the FIGS. 42 and 43 of the appendix. The luminance output however will be according FIG. 32 below. On top the results are shown of level 4″ only, at the bottom of level 1″ to 4″. On the left the UCS1976 color space is shown and on the right the Chrominance″ space. It can be seen independent of the level that at the borders luminance errors will occur. This counts for all colors inside the color space that are crossing the outside borders at larger increasing values of the saturation control.

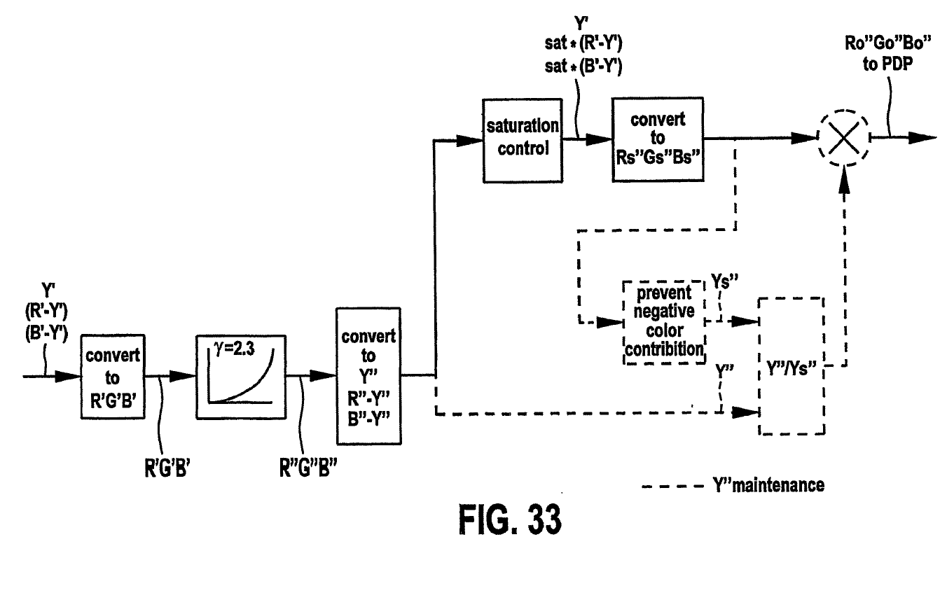

A method to prevent this increase of the luminance output is to apply the luminance output maintenance of the PDP as function of the saturation control as shown in FIG. 33. The dashed part shows the needed extra circuitry in comparison with FIG. 31.

After the saturation control and the conversion to the Rs″,Gs″and Bs″ signals, negative primary color contributions are set to zero in the block “prevent negative color contribution” according to:
if Rs″<0 then Rs″=0
if Gs″<0 then Gs″=0
if Bs″<0 then Bs″=0

Next the luminance signal Ys″ is calculated with those signals, which are larger or equal to zero:
Ys″=Y_{Rdisplay}×Rs″+Y_{Gdisplay}×Gs″+Y_{Bdisplay}×Bs″

For a proper luminance″ maintenance it is necessary to use the luminance contributions of the PDP. This also means that after the simulation of the CRT transfer the PDP luminance contribution should be used in the conversion of R″G″B″ to the Y″, R″−Y″ and B″−Y″ and again in the conversion to the Rs″Gs″Bs″ signals. For Y″ counts:
Y″=Y_{Rdisplay}×R″+Y_{Gdisplay}×G″+Y_{Bdisplay}×B″

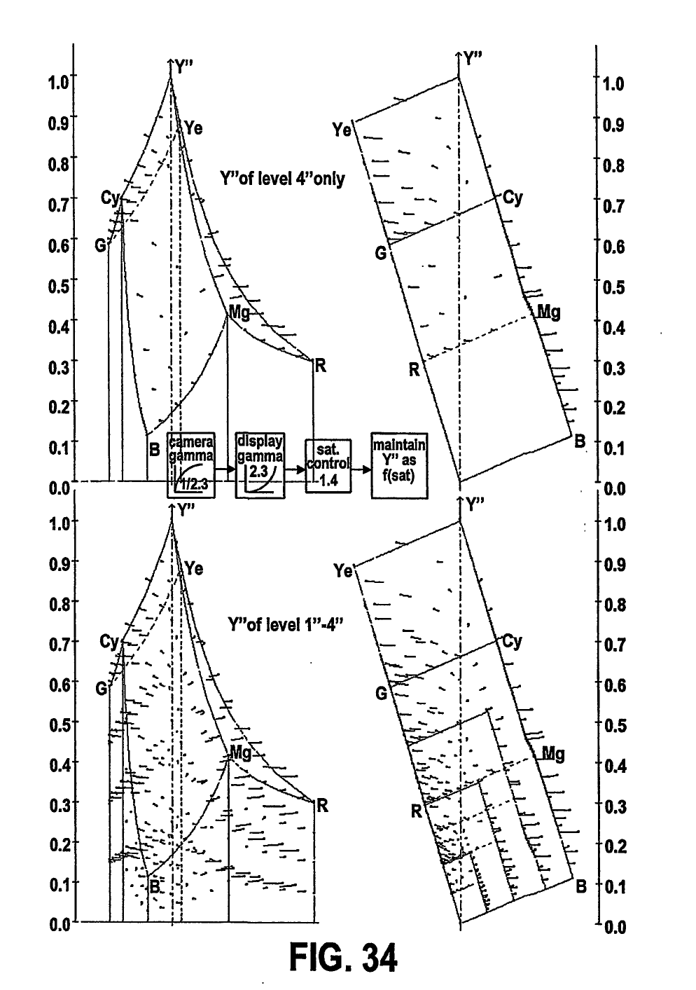

Using the PDP luminance contributions will result in a somewhat different saturation control then with the FCC primaries. The difference are however rather small and the Y″ maintenance will minimize them further. For the latter function counts that:
Ro″=Rs″×Y″/Ys″
Go″=Gs″×Y″/Ys″
Bo″=Bs″×Y″/Ys″,
which signals are sent to the PDP. The result of this PDP luminance″ output maintenance is shown in FIG. 34.
3.6 Extra Amplification of the Luminance″ Output when Maintaining Y″ as f(sat)

A CRT display and a PDP display respectively allows a larger luminance″ output than an LCD display. Depending on the type of display it is possible to multiply the correction factor (Y1″/Ys″) for maintaining the luminance output of the display with a (small) gain factor at an increasing saturation control. For equation (6) of FIG. 14 this means that the correction factor (Y1″/Ys″) will be multiplied with a factor called ‘ExtraYmaintenance’. This results in a modified equation (6) as follows:
Ro″=Rs″×(ExtraYmaintenance×Y1″/Ys″)
Go″=Gs″×(ExtraYmaintenance×Y1″/Ys″)
Bo″=Bs″×(ExtraYmaintenance×Y1″/Ys″) (11)

For the parameter ExtraYmaintenance it counts that it is the product of a first variable called ‘YmaintGain’ that can be adjusted somewhat larger than unity, and a second parameter RGBsat″ being a measure of the true amount of color saturation of a pixel. The extra luminance output of the display becomes active when the saturation control is larger than one, i.e.:

| If sat > 1.0 then | |
|---|---|
| ExtraYmaintenance = 1 + (YmainGain − 1) × RGBsat″ | (12) |
| else ExtraYmaintenance = 1.0 | |
| the RGBsat″ parameter counts: | |
| RGBsat″ = (RGB″−RGBmin″)/RGBmax″ | (13) |

Here RGBmax″ represents the maximum of the three R″G″B″ signals and RGBmin″ their minimum.

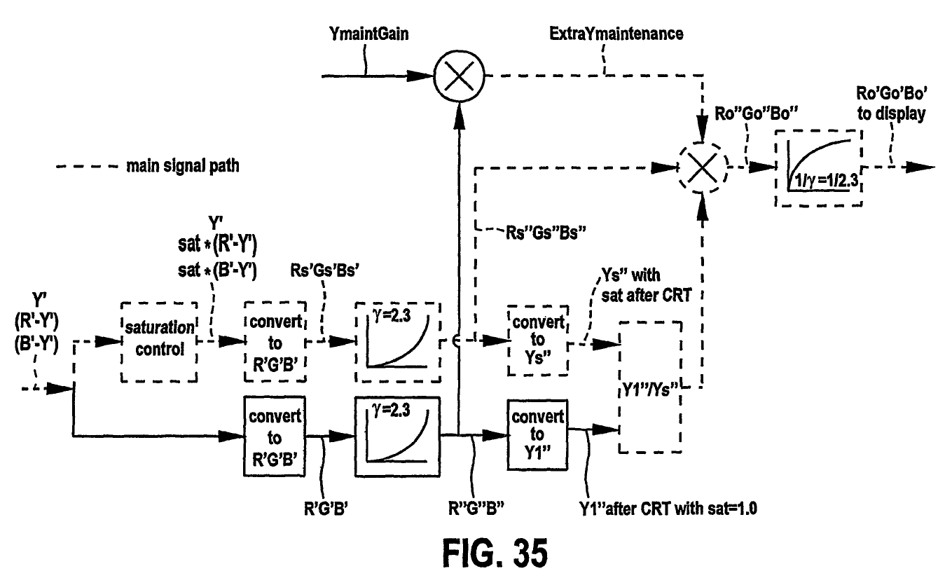

Adding ExtraYmaintenance to FIG. 14 results in FIG. 35. The dashed lines show the main signal path.

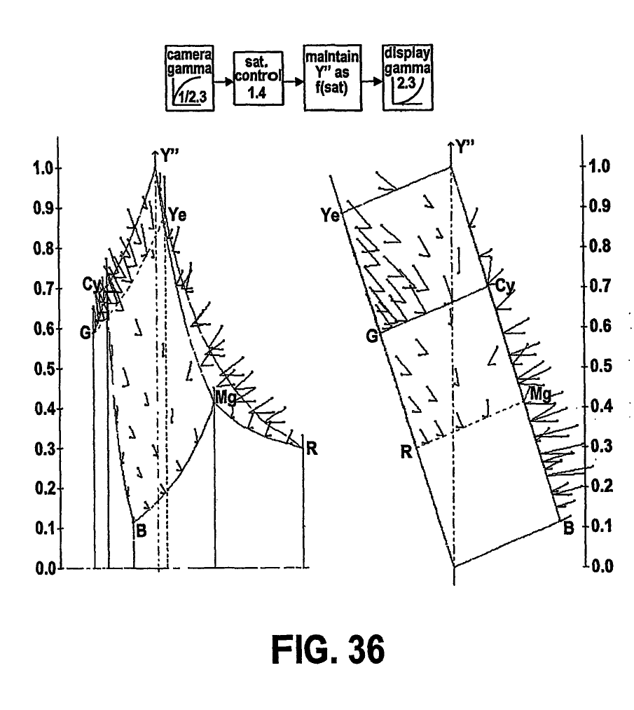

An example of the UCS1976 and chrominance″ space with Y″ in the vertical direction will be given of the use of ExtraYmaintenance for sat=1.4 and YmaintGain=1.10, being the slanted arrows in FIG. 36. As a reference also the results without ExtraYmaintenance (YmaintGain=1.0) are shown with horizontal arrows.

The reason of the RGBsat″ parameter in equation (12) is that RGBsat″ linearly increases as function of the saturation of a color pixel. This prevents a not desired extra gain for gray colors lying on the Y″ axis and offers a proportional increasing ExtraYmaintenance towards the borders at a complementary camera and CRT gamma For YmaintGain=1.10 at the borders a maximum luminance″ increase of 10% will occur. This also counts for the RGBmax″ output at the borders.

For a complementary camera and CRT gamma the R″G″B″ signals in FIG. 35 are linear. As a consequence the RGBsat″ parameter increases linear towards the borders. In stead of the RGBsat″ signal it is however also possible to apply the RGBsat′ signal using the R′G′B′ signals before the simulation of the CRT gamma. The only difference with the RGBsat″ signal is that the increase of ExtraYmaintenance now will be non-linear towards the borders. For the two luminance″ maintenance diagrams with less processing in the signal path as shown in the FIGS. 29 and 30 the equations (8) and (9) have to be modified for making ExtraYmaintenance possible.

Equation (8) Becomes:
Ro′=Rs′×(ExtraYmaintenance×Y1″/Ys″)^{1/γ}
Go′=Gs′×(ExtraYmaintenance×Y1″/Ys″)^{1/γ}
Bo′=Bs′×(ExtraYmaintenance×Y1″/Ys″)^{1/γ} (14)
For Equation (9) it Holds:
Yo′=Y′×(ExtraYmaintenance×Y1″/Ys″)^{1/γ}
(R′−Y′)o=sat×(R′−Y′)×(ExtraYmaintenance×Y1″/Ys″)^{1/γ}
(B′−Y′)o=sat×(B′−Y′)×(ExtraYmaintenance×Y1″/Ys″)^{1/γ} (15)

Analog to Equation (12) Counts that:

| | |
|---|---|
| If sat > 1.0 then | |
| ExtraYmaintenance = 1 + (YmainGain − 1) × RGBsat′ | (16) |
| else ExtraYmaintenance = 1.0 | |

It is to be noticed that in equation (16) RGBsat′ has been applied in stead of RGBsat″ in equation (12).

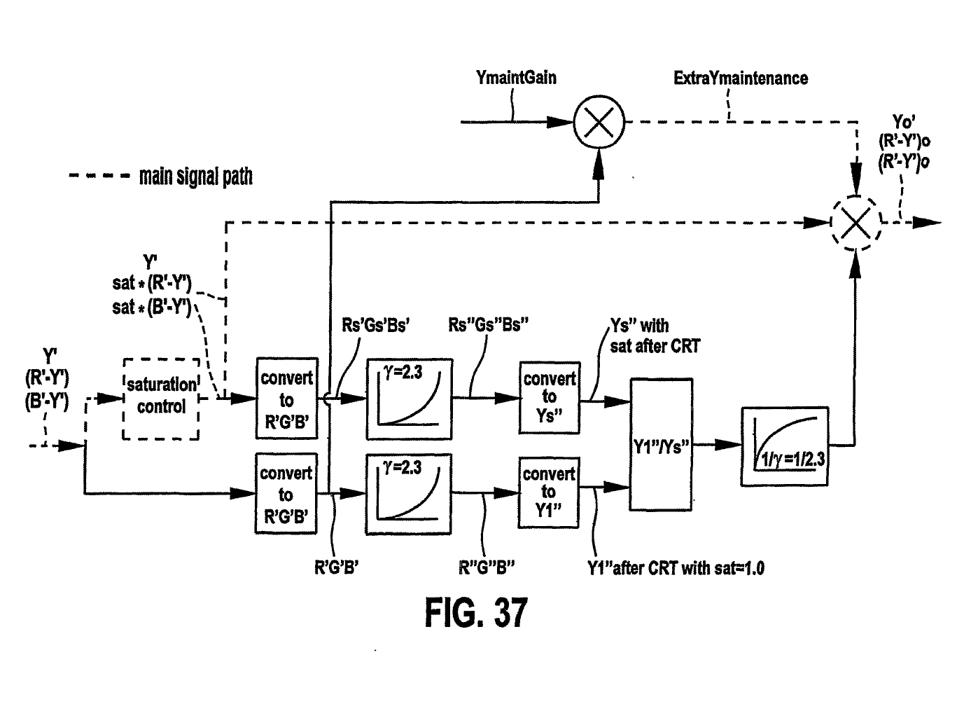

Because of the resemblance between FIG. 29 and 30 only of the latter a block diagram is shown with the ExtraYmaintenance multiplication. As FIG. 37 makes clear, the ExtraYmaintenance multiplication takes place in the non-linear space between camera and CRT gamma using the non-linear R′G′B′ signals for obtaining the RGBsat′ signal. After the CRT the luminance″ output will increase proportionally towards the borders as function of RGBsat′. The main signal path is shown as dashed lines.

Appendix Color Saturation Control in the Linear Color Space

FIG. 38 shows the effects of a saturation control of 1.2 for the 67 reference points in the 2D linear chrominance and UCS1976 plane. As can be seen, the reference points move outwards the borders via a line through the white and the reference point. The larger the distance of the reference points from white, the larger the saturation increase will be. Only for a chrominance plane with unreduced color difference signals the saturation increase will be equal for colors with a proportional distance to the border colors. The saturation increase of FIG. 38 slightly differs from the one with unreduced color difference signals because here the circle 2 approximation has been applied.

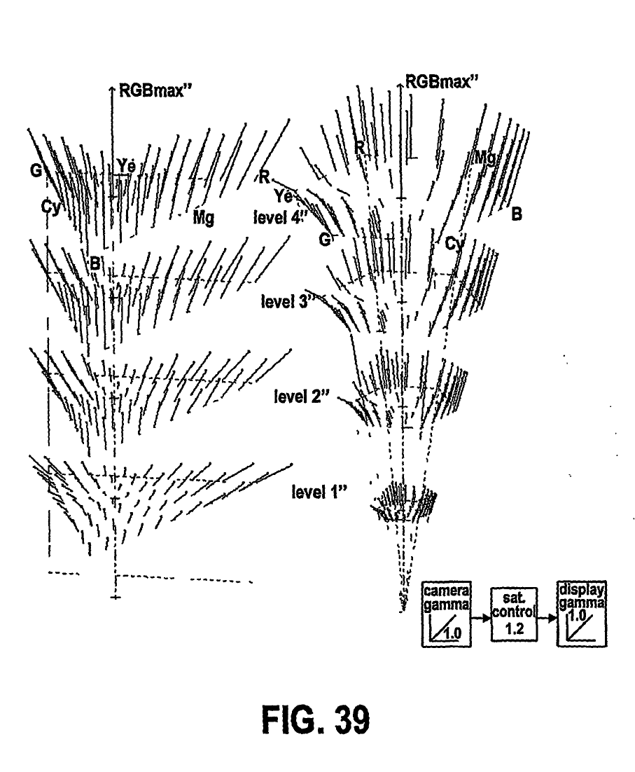

FIG. 39 shows an increase of 20% of the saturation control in the linear 3D RGBmax color space. The 3D saturation increase can be seen as the composition of two vectors. One vector in the horizontal plane, representing a kind of a saturation component (In this RGBmax 3D color space is spoken about ‘a kind of a saturation component’ because the definition of saturation depends on the color space used. As will become clear in section 3.2 the saturation component in the 3D color space with the luminance signal as vertical dimension will differ from the one with RGBmax.), and another vector in the vertical direction, being the RGBmax amplitude increase. Emphasized is that the latter represents the signal increase of only one of the three RGB colors. This is true except for the Ye-Cy-Ma complementary colors where two of the three signals have an equal maximum. In order to prevent color reproduction errors the electronic circuitry as well as the display and its drivers should be able to handle this RGBmax signal. The top projections of the four levels of the UCS1976 space are the very same. They are all equal to the UCS1976 plane in FIG. 38. Regarding the top projections of the chrominance space only level 4 corresponds with FIG. 38.

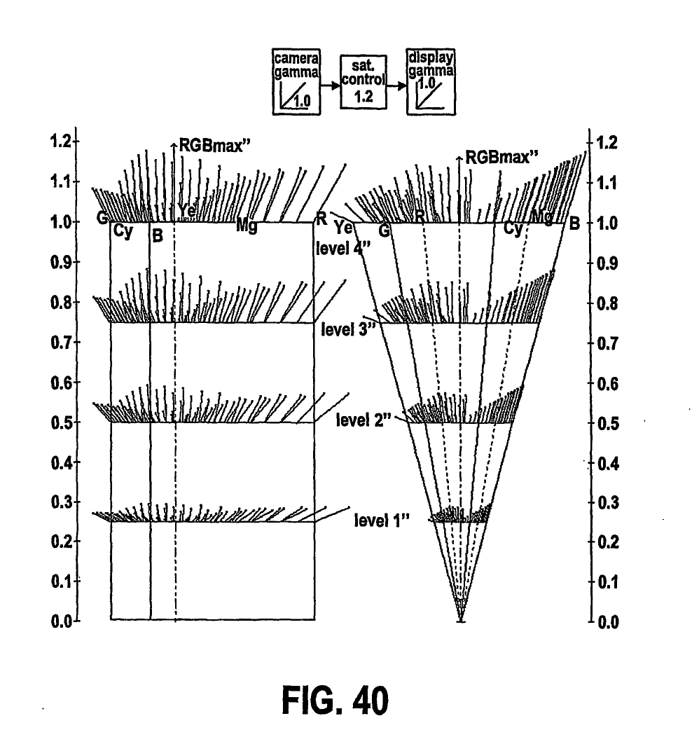

FIG. 40 shows the side projection of FIG. 39. It gives an impression of the RGBmax amplitude due to a 20% increase of the saturation control. On top, at level 4, the largest amplitude has the B-signal for the blue color: i.e. B=1, R=G=0, and B=sat×(B−Y)+Y=1.2×(1−0.114)+0.114=1.1772, i.e. an increase of RGBmax of 0,1772. Regarding the fully saturated linear input colors at the border of level 4 the yellow color has the smallest RGBmax value. The increase of the RGBmax signal of an arbitrary color is proportional to the RGBmax increase on the top (level 4) multiplied with the ratio of the linear RGBmax input signal and the range. An example: at level 3 the increase of RGBmax of the blue color with R=0.75, R=G=0 is 0.1772×0.75/range. In this case the range is 1 Volt.

All colors in FIG. 39 with a saturation arrow going outside the UCS1976 space, have a negative primary color contribution. In FIG. 41 is shown where negative RGB contributions occur. So far the signal processing circuitry is able to handle negative color signals, which can be seen when analysing its color reproduction. In case of color analysis of laboratory pictures during signal processing, the contribution of negative colors may lead to the wrong conclusion that the original camera color gamut has been larger than the one of the EBU/HDTV. By limiting the negative colors to zero this can however be checked.

Again referring to FIG. 1 it should further be mentioned not to clip the negative RGB signals to zero before the display matrix. This would cause irreparable color reproduction errors, while the goal of the display matrix is to minimize color errors.

Finally with regard to the above mentioned color analysis of laboratory pictures during signal processing, wherein the contribution of negative colors may lead to the wrong conclusion that the original camera color gamut has been larger than the one of the EBU/HDTV now, with the aid of FIG. 42 and 62, it will be explained what happens if negative color signals are limited to zero.

FIG. 42 shows the color reproduction when the negative colors due to a saturation control of 1.2 are limited to zero. When comparing it with FIG. 38 it becomes clear that the oversaturated colors at the borders will stay within the UCS1976 gamut but shifted towards the RGB primaries. The result in the chrominance plane is rather misleading because it still looks like the saturation has increased. This ‘increase’ is caused by the cone shape of the 3D chrominance space.

Although the negative colors are clipped, on the right side of FIG. 43 can be seen that the amplitude component of the color vector follows the outer chrominance cone space. This again makes clear that a 2D analysis in the chrominance or Chroma plane can be very misleading and that it helps to show the 2D UCS1976 plane as well. When comparing FIG. 43 with FIG. 39 can be seen that limiting the negative color contribution does not influence the vertical RGBmax component of a color.

The top projections of the four levels of the UCS1976 space are the very same. They are all equal to the UCS1976 plane in FIG. 42. Of the top projections of the chrominance space only level 4 corresponds with FIG. 42.

Summarizing, in present television sets, user color saturated control is executed in a non-linear signal domain due to the gamma conversion inherent of the camera. This results in the display of exaggerated colors when the saturated control is increased. The present invention provides a A luminance control method comprising the steps of:
providing an original image signal ((Y′, R′−Y′, B′−Y′)) having a luminance component (Y′) and a color component (R′−Y′, B′−Y′) to a first processing stream and a second processing stream,

wherein

the first processing stream comprises the steps of:

applying a saturation control to the original image signal ((Y′, R′−Y′, B′−Y′)) resulting in a saturation controlled image signal ((Y′, sat*(R′−Y′), sat*(B′−Y′))), and predicting a first predicted image signal ((Ys″, Rs″−Ys″, Bs″−Ys″)) by further processing thereof;

the second processing stream comprises the steps of:

predicting a second predicted image signal ((Y1″, R1″−Y1″, B1″−Y1″)) by processing of the original image signal ((Y′, R′−Y′, B′−Y′));
providing a correction factor (Y1″/Ys″) by comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″));
applying the correction factor (Y1″/Ys″) to correct one of the image signals of the first processing stream to give a display signal ((Ro′, Go′, Bo′)).

Thereby the current invention maintains the luminance output as a function of the saturation control. I.e. the luminance of the display is predicted for the case where the saturation is amended. This predicted luminance is higher or lower due to the increased or decreased saturation and compared with the predicted luminance with unamended saturation. This comparison provides a correction factor that is applied to an image signal with amended saturation before the image signal is applied to the display. The result is that at an increasing saturation control a very natural change of the colors occurs where the conventional method of saturation control will cause an exaggerated and unnatural color reproduction.

Prominent embodiments of the invention have been outlined with regard to FIG. 14, 29 and 30.

1. A luminance control method comprising the steps of:
providing an original image signal ((Y′, R′−Y′, B′−Y′)) having a luminance component (Y′) and a color component (R′−Y′, B′−Y′) to a first processing stream and a second processing stream,
wherein
the first processing stream comprises the steps of:
applying a saturation control to the original image signal ((Y′, R′−Y′, B′−Y′)) resulting in a saturation controlled image signal ((Y′, sat*(R′−Y′), sat*(B′−Y′))), and
predicting a first predicted image signal ((Ys″, Rs″−Ys″, Bs″−Ys″)) by further processing thereof;
the second processing stream comprises the steps of:
predicting a second predicted image signal ((Y1″, R1″−Y1″, B1″−Y1″)) by processing of the original image signal ((Y′, R′−Y′, B′−Y′));
providing a correction factor (Y1″/Ys″) by comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″)); applying the correction factor (Y1″/Ys″) to correct one of the image signals of the first processing stream to give a display signal ((Ro′, Go′, Bo′)).

2. The method as claimed in claim 1, characterized in that
the first processing stream comprises the steps of:
applying the saturation control to a color component (R′−Y′, B′−Y′) of the original image signal ((Y′, R′−Y′, B′−Y′)) resulting in the saturation controlled image signal (Y′, sat*(R′−Y′), sat*(B′−Y′)) and
predicting the first predicted image signal ((Ys″, Rs″−Ys″, Bs″−Ys″)) by:
converting the saturation controlled image signal ((Y′, sat*(R′−Y′), sat*(B′−Y′))) into a first saturation controlled RGB-image signal ((Rs′, Gs′, Bs′)) having a saturation controlled red (Rs′), green (Gs′) and blue (Bs′) color component,
gamma-converting the first saturation controlled RGB-image signal ((Rs′, Gs′, Bs′)) into a second saturation controlled RGB-image signal ((Rs″, Gs″, Bs″)), and
converting the second saturation controlled RGB-image signal ((Rs″, Gs″, Bs″)) into the first predicted image signal (Ys″, Rs″−Ys″, Bs″−Ys″).

3. The method as claimed in claim 1, characterized in that
the second processing stream comprises the steps of:
predicting the second predicted image signal ((Y1″, R1″−Y1″, B1″−Y1″)) by:
converting the original image signal ((Y′, R′−Y′, B′−Y′)) into a first RGB-image signal ((R′, G′, B′)) having a red (R′), green (G′) and blue (B′) color component,
gamma-converting the first RGB-image signal (R′, G′, B′) into a second RGB-image signal ((R″, G″, B″)), and
converting the second RGB-image signal ((R″, G″, B″)) into the second predicted image signal ((Y1″, R1″−Y1″, B1″−Y1″)).

4. The method as claimed in claim 2, characterized in that the correction factor (Y1″/Ys″) is applied by:
multiplying the second saturation controlled RGB-image signal ((Rs″, Gs″, Bs″)) with the correction factor (Y1″/Ys″), and
inversely gamma-converting the multiplied second saturation controlled RGB-image signal ((Ro″, Go″, Bo″)) to give the display signal ((Ro′, Go′, Bo′)) (FIG. 14).

5. The method as claimed in claim 2, characterized in that the correction factor (Y1″/Ys″) is applied by:
inversely gamma-converting the correction factor (Y1″/Ys″), and
multiplying the first saturation controlled RGB-image signal ((Rs′, Gs′, Bs′)) with the inversely gamma-converted correction factor (Y1″/Ys″) to give the display signal ((Ro′, Go′, Bo′)) (FIG. 29).

6. The method as claimed in claim 2, characterized in that the correction factor (Y1″/Ys″) is applied by:
inversely gamma-converting the correction factor (Y1″/Ys″), and
multiplying the saturation controlled image signal ((Y′, sat*(R′−Y′), sat*(B′−Y′))) with the inversely gamma-converted correction factor (Y1″/Ys″) to give the display signal ((Ro′, Go′, Bo′)) (FIG. 30).

7. A luminance control apparatus (11, FIG. 14a) for controlling the luminance comprising:
an input means (12) for providing an original image signal ((Y′, R′−Y′, B′−Y′)) having a luminance component (Y′) and a color component (R′−Y′, B′−Y′) to a first processing stream (14) and a second processing stream (16),
wherein
the first processing stream (14) comprises:
a control means (14a) for applying a saturation control to the original image signal ((Y′, R′−Y′, B′−Y′)) resulting in a saturation controlled image signal ((Y′, sat*(R′−Y′), sat*(B′−Y′))), and
a first prediction means (14b) for predicting a first predicted image signal ((Ys″, Rs″−Ys″, Bs″−Ys″)) by further processing thereof;
the second processing stream (16) comprises:
a second prediction means (16a) for predicting a second predicted image signal ((Y1″, R1″−Y1″, B1″−Y1″)) by processing of the original image signal ((Y′, R′−Y′, B′−Y′));
a comparator means (18) for providing a correction factor (Y1″/Ys″) and comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″));
an operator means (19) for applying the correction factor (Y1″/Ys″) to correct one of the image signals of the first processing stream (14) to give a display signal ((Ro′, Go′, Bo′)).

8. The luminance control apparatus (11) as claimed in claim 7, characterized in that the first processing stream (14) comprises:
a control means (14a) for applying a saturation control to the original image signal ((Y′, R′−Y′, B′−Y′)) resulting in a saturation controlled image signal ((Y′, sat*(R′−Y′), sat*(B′−Y′))), and
a first prediction means (14b) for predicting a first predicted image signal ((Ys″, Rs″−Ys″, Bs″−Ys″)) by (FIG. 14b):
converting (20) the saturation controlled image signal ((Y′, sat*(R′−Y′), sat*(B′−Y′))) into a first saturation controlled RGB-image signal ((Rs′, Gs′, Bs′)) having a saturation controlled red (Rs′), green (Gs′) and blue (Bs′) color component,
gamma-converting (22) the first saturation controlled RGB-image signal ((Rs′, Gs′, Bs′)) into a second saturation controlled RGB-image signal ((Rs″, Gs″, Bs″)), and
converting (24) the second saturation controlled RGB-image signal ((Rs″, Gs″, Bs″)) into the first predicted image signal ((Ys″, Rs″−Ys″, Bs″−Ys″)).

9. The luminance control apparatus (11) as claimed in claim 7, characterized in that
the second processing stream (16) comprises:
a second prediction means (16a) for predicting a second predicted image signal ((Y1″, R1″−Y1″, B1″−Y1″)) by (FIG. 14c):
converting (26) the original image signal ((Y′, R′−Y′, B′−Y′)) into a first RGB-image signal ((R′, G′, B′)) having a red (R′), green (G′) and blue (B′) color component,
gamma-converting (28) the first RGB-image signal ((R′, G′, B′)) into a second RGB-image signal ((R″, G″, B″)), and
converting (30) the second RGB-image signal ((R″, G′, B″)) into the second predicted image signal ((Y1″, R1″−Y1″, B1″−Y1″)).

10. The luminance control apparatus (11, FIG. 14a) for controlling the luminance comprising:
an input means (12) for providing an original image signal ((Y′, R′−Y′, B′−Y′)) having a luminance component (Y′) and a color component (R′−Y′, B′−Y′) to a first processing stream (14) and a second processing stream (16),
wherein
the first processing stream (14) comprises:
a control means (14a) for applying a saturation control to the original image signal ((Y′, R′−Y′, B′−Y′)) resulting in a saturation controlled image signal ((Y′, sat*(R′−Y′), sat*(B′−Y′))), and
a first prediction means (14b) for predicting a first predicted image signal ((Ys″, Rs″−Ys″, Bs″−Ys″)) by further processing thereof;
the second processing stream (16) comprises:
a second prediction means (16a) for predicting a second predicted image signal ((Y1″, R1″−Y1″, B1″−Y1″)) by processing of the original image signal ((Y′, R′−Y′, B′−Y′));
a comparator means (18) for providing a correction factor (Y1″/Ys″) and comparing the luminance (Ys″) of the first predicted image signal ((Ys″, Rs″−Ys″, Bs″−Ys″)) to the luminance (Y1″) of the second predicted image signal ((Y1″, R1″−Y1″, B1″−Y1″));
an operator means (19) for applying the correction factor (Y1″/Ys″) to correct one of the image signals of the first processing stream (14) to give a display signal ((Ro′, Go′, Bo′)), characterized in that the operator means (19) for applying the correction factor (Y1″/Ys″) is adapted to execute the method steps as claimed in claim 4.

11. The luminance control apparatus (11) as claimed in claim 7, being formed by an imaging system (1) (FIG. 1) comprising:
register means (2) for registering an image (3) and providing the original image signal (4),
transfer means (5) for coding (6), transfering (7) and decoding (8) the original image signal (4), and
display means (9) for receiving the original image signal (4) and displaying the image (3) by the display signal (10).

12. The luminance control apparatus (11) as claimed in claim 7, being formed by
a display means (9) for receiving an image (3) in form of the original image signal (4) and displaying the image (3) by the display signal (10),
wherein in particular said luminance control apparatus (11) is formed as an LCD display, in particular as an computer LCD display.

13. The luminance control apparatus (11) as claimed in claim 7, being formed by
a display means (9) for receiving an image (3) in form of the original image signal (4) and displaying the image (3) by the display signal (10),
wherein in particular said control apparatus (11) is formed as a printer, in particular as a printer for a computer.

14. A computer program product storable on a medium readable by a computing, imaging and/or printer system, comprising a software code section which induces the computing, imaging and/or printer system to execute the method as claimed in claim 1 when the product is executed on the computing, imaging and/or printer system.

15. A computing, imaging and/or printer system and/or semiconductor device and/or storage medium for executing and/or storing a computer program product as claimed in claim 14.
